(19) United States
(12) Patent Application Publication
(10) Pub. No.: US 2023/0055545 A1
(43) Pub. Date: Feb. 23, 2023

(54) IRRADIATION DEVICES WITH LASER DIODE ARRAYS FOR ADDITIVELY MANUFACTURING THREE-DIMENSIONAL OBJECTS

(71) Applicant: General Electric Company, Schenectady, NY (US)

(72) Inventor: Mary Kathryn Thompson, Fairfield Township, OH (US)

(21) Appl. No.: 17/892,532

(22) Filed: Aug. 22, 2022

Related U.S. Application Data
(60) Provisional application No. 63/235,327, filed on Aug. 20, 2021.

(51) Int. Cl. B22F 12/45; B29C 64/268; B29C 64/282; B33Y 30/00; B23K 26/06; B23K 26/08

(52) U.S. Cl. CPC B22F 12/45; B29C 64/268; B29C 64/282; B33Y 30/00; B23K 26/0604; B23K 26/0648; B23K 26/0869; B23K 26/0665

(57) ABSTRACT

An irradiation device for additively manufacturing three-dimensional objects may include a beam generation device that includes a plurality of laser diode arrays. Respective ones of the plurality of laser diode arrays may include a plurality of diode emitters respectively configured to emit an energy beam. The plurality of laser diode arrays may be longitudinally offset relative to one another, and the plurality of laser diode arrays may be laterally offset relative to one another.

### PRIORITY INFORMATION

The present application claims priority to U.S. Provisional Application Number 63/235,327 filed on Aug. 20, 2021, which is incorporated by reference herein for all purposes.

### FIELD

The present disclosure generally pertains to irradiation devices for irradiating powder material to additively manufacture three-dimensional objects, such as irradiation devices used in powder bed fusion processes.

### BACKGROUND

Three dimensional objects may be additively manufactured using a powder bed fusion process in which an energy beam generated by an irradiation device is directed onto a powder bed to melt and/or sinter sequential layers of powder material. The properties of the three dimensional object formed by melting and/or fusing the powder material may depend at least in part on one or more characteristics of the energy beam provided by the irradiation device and/or on the irradiation sequence performed by the irradiation device. Accordingly, it would be welcomed in the art to provide improved additive manufacturing systems and machines, including improved energy beam systems and/or irradiation devices, as well as improved irradiation sequences that may be performed by such energy beam systems and/or irradiation devices.

### BRIEF DESCRIPTION OF THE DRAWINGS

A full and enabling disclosure, including the best mode thereof, directed to one of ordinary skill in the art, is set forth in the specification, which makes reference to the appended Figures, in which:

FIGS. 1A and 1B schematically depict exemplary additive manufacturing systems or machines;

FIGS. 2A and 2B schematically depict further exemplary additive manufacturing systems or machines;

FIG. 3A schematically depicts an exemplary irradiation device;

FIG. 3B schematically depicts an exemplary laser diode array and an exemplary beam conditioning assembly that may be included in an irradiation device;

FIG. 3C schematically depicts another exemplary laser diode array that may be included in an irradiation device;

FIGS. 4A and 4B schematically depict exemplary energy beam systems that include a plurality of irradiation devices mounted to a positioning system;

FIGS. 5A-5E schematically depict exemplary arrangements for a plurality of laser diode arrays;

FIGS. 6A and 6B schematically depict further exemplary arrangements for a plurality of laser diode arrays;

FIGS. 6C and 6D schematically depict an exemplary actuator that may be utilized to adjust a position of a laser diode array;

FIGS. 7A-7D schematically depict further exemplary arrangements for a plurality of laser diode arrays;

FIG. 8A schematically depicts a perspective view of an irradiation device performing an exemplary irradiation sequence;

FIGS. 8B-8G schematically depict a side view of an irradiation device performing an exemplary irradiation sequence;

FIG. 9 schematically depicts an exemplary controls system; and

FIG. 10 is a flow chart depicting an exemplary method of additively manufacturing a three-dimensional object.

Repeat use of reference characters in the present specification and drawings is intended to represent the same or analogous features or elements of the present disclosure.

### DETAILED DESCRIPTION

Reference now will be made in detail to exemplary embodiments of the presently disclosed subject matter, one or more examples of which are illustrated in the drawings. Each example is provided by way of explanation and should not be interpreted as limiting the present disclosure. In fact, it will be apparent to those skilled in the art that various modifications and variations can be made in the present disclosure without departing from the scope of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

It is understood that terms “upstream” and “downstream” refer to the relative direction with respect to fluid flow in a fluid pathway. For example, “upstream” refers to the direction from which the fluid flows, and “downstream” refers to the direction to which the fluid flows. It is also understood that terms such as “top”, “bottom”, “outward”, “inward”, and the like are words of convenience and are not to be construed as limiting terms. As used herein, the terms “first”, “second”, and “third” may be used interchangeably to distinguish one component from another and are not intended to signify location or importance of the individual components. The terms “a” and “an” do not denote a limitation of quantity, but rather denote the presence of at least one of the referenced item.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The present disclosure generally provides additive manufacturing machines and methods of additively manufacturing three-dimensional objects. Exemplary additive manufacturing machines may utilize irradiation devices that include a plurality of laser diode arrays configured for a powder bed fusion process. The plurality of laser diode arrays may be configured to work in concert with one another to irradiate a powder bed with a linear or curvilinear pattern of beam spots. At least some of the beam spots from respective ones of the plurality of laser diode arrays may become incident upon the powder bed in an alternating pattern or sequence. The alternating pattern or sequence of beam spots may allow for an effective pitch length that is smaller than the effective pitch length of the laser diode arrays. The smaller effective pitch may provide a pattern of beam spots that are sufficiently close to one another to avoid potential gaps between adjacent melt tracks.

The alternating pattern or sequence may allow for linear or curvilinear irradiation patterns while providing improved control of heat input and melt pool geometry. For example, build points that are irradiated by a linear or curvilinear patterns of beam spots may have a tendency to thermally interact with one another as heat conduction from adjacent build points propagates across the powder bed. These interactions may introduce variability in the localized energy density of respective build points, which variability can lead to variable melt pool size and geometry. For example, heat conduction from adjacent build points may cause heat conduction gradient transverse to the adjacent build points, which may lead to an ovalized and/or irregularly shaped melt pool. The nature and extent of the variability may depend on the distance between adjacent beam spots, the power density or intensity of adjacent beam spots, and/or the proportion of the local area of the powder bed being irradiated, among other things. The presently disclosed alternating pattern or sequence of beam spots may reduce the tendency for adjacent build points to introduce variability with respect to one another, which may allow a more uniform power density and/or improved controllability of the power density at the respective build points. The improved uniformity and/or controllability may provide for improved build quality and/or uniformity. Additionally, or in the alternative, the presently disclosed alternating pattern or sequence of beam spots may allow for increased processing speeds, for example, without sacrificing build quality and/or uniformity. Advantageously, such increased processing speeds may further reduce the tendency for thermal interactions from adjacent build points, which may lead to even further improvements in build quality and/or uniformity.

In addition to the presently disclosed irradiation devices having a plurality of laser diode arrays that provide an alternating pattern or sequence of beam spots, exemplary irradiation devices may include laser diode arrays that emit energy beam segments with a relatively lower intensity and/or power density in comparison to existing irradiation devices and/or laser diode arrays typically utilized in powder bed fusion processes. For example, an irradiation device may include a plurality of laser diode arrays that emit a plurality of energy beams that impart a power density and/or intensity to the build plane commensurate with a conduction irradiation regime. As used herein, the term “conduction irradiation” or “conduction irradiation regime” refers to an irradiation regime in a powder bed fusion process in which heat is transferred into the powder bed predominately through heat conduction such that the thermal conductivity of the powder material is the limiting factor for the depth of the melt pool. The temperature of the melt pool with conduction irradiation generally remains below the vaporization temperature of the powder material. With a conduction irradiation regime, the width of a melt pool is typically much greater than the depth of the melt pool. A melt pool resulting from conduction irradiation may have an aspect ratio of less than about 1.0 (width/depth), such as from about 0.1 to about 1.0, such as from about 0.1 to about 0.5, or such as from about 0.5 to about 1.0. A melt pool resulting from conduction irradiation may have a depth of from about 10 micrometers (μm) to about 250 μm, such as from about 10 μm to about 50 μm, such as from about 50 μm to about 100 μm, or such as from about 100 μm to about 250 μm.

Conduction irradiation may be differentiated from penetration irradiation. As used herein, the term “penetration irradiation” or “penetration irradiation regime” refers to an irradiation regime in a powder bed fusion process in which the temperature of the melt pool exceeds the vaporization temperature of the powder material to an extent that the energy beams penetrate into a vapor capillary formed by expanding gasses releasing from the vaporizing power material. With penetration irradiation, the temperature of the melt pool adjacent to the vapor capillary generally exceeds the vaporization temperature of the powder material. With a penetration irradiation regime, the width of a melt pool is typically much smaller than the depth of the melt pool. A melt pool resulting from penetration irradiation may have an aspect ratio of greater than about 1.0 (width/depth), such as from about 1.0 to about 18.0, such as from about 1.0 to about 5.0, such as from about 5.0 to about 10.0, or such as from about 10.0 to about 18.0. A melt pool resulting from penetration irradiation may have a depth of from about 100 μm to about 1 millimeter (mm), such as from about 100 μm to about 250 μm, such as from about 250 μm to about 500 μm, or such as from about 500 μm to about 800 μm.

An irradiation device that includes a plurality of laser diode arrays configured and arranged in accordance with the present disclosure may be advantageously utilized with a conduction irradiation regime. The relatively lower intensity and/or power density associated with conduction irradiation may allow for a plurality of laser diode arrays to be configured and arranged to provide an alternating pattern of beam spots with a relatively low pitch between respective beam spots, thereby allowing for increased resolution when irradiating the powder bed without causing excessive thermal interactions between adjacent beam spots. The increased resolution realized by the present disclosure may be utilized to facilitate sophisticated irradiation strategies that provide for improved temperature control and/or improved material properties of three dimensional objects formed during an additive manufacturing process. Additionally, or in the alternative, the increased resolution realized by the present disclosure may be utilized to produce three dimensional objects that have smaller features, improved surface properties, and/or greater dimensional tolerances.

A plurality of energy beams respectively corresponding to a plurality of laser diodes from the laser diode arrays may be directed onto the build plane, providing a plurality of beam spots in the form of an alternating pattern, such as an alternating pattern of beam spots with a linear or curvilinear arrangement. The linear or curvilinear arrangement of beam spots may be scanned across the powder bed while respective laser diodes may be modulated according to irradiation instructions. The irradiation instructions may specify which build points on the powder bed are intended to receive irradiation from a beam spot corresponding to a respective one or more laser diodes from the plurality of laser diode arrays. The powder bed can be irradiated with good resolution while the beam spots are modulated by the respective laser diodes. With a conduction irradiation regime, heat transfer from adjacent beam spots may be limited by the thermal conductivity of the powder material, and as such, the melt pool corresponding to respective beam spots can be substantially confined to specified build points of the powder bed. In some embodiments, the presently disclosed additive manufacturing machines may allow for a powder bed to be irradiated with a resolution that approaches or corresponds to a cross-sectional width of a beam spot.

As described herein, the presently disclosed subject matter involves the use of additive manufacturing machines or systems. As used herein, the term “additive manufacturing” refers generally to manufacturing technology in which components are manufactured in a piece-by-piece or layer-by-layer manner. An exemplary additive manufacturing machine may be configured to utilize any suitable additive manufacturing technology. The additive manufacturing machine may utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects are generally monolithic in nature and may have a variety of integral sub-components.

Additionally or alternatively suitable additive manufacturing technologies may include, for example, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, Vat Polymerization (VP) technology, Stereolithography (SLA) technology, and other additive manufacturing technologies that utilize an energy beam or other energy source to solidify an additive manufacturing material such as a powder material. In fact, any suitable additive manufacturing modality may be utilized with the presently disclosed the subject matter.

Additive manufacturing technology may generally be described as fabrication of objects by building objects point-by-point, line-by-line, or layer-by-layer, typically in a vertical direction. Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

The additive manufacturing processes described herein may be used for forming components using any suitable material. For example, the material may be metal, ceramic, polymer, epoxy, photopolymer resin, plastic, concrete, or any other suitable material that may be in solid, liquid, powder, sheet material, wire, or any other suitable form, or combinations thereof. Exemplary materials may include metals, polymers, or ceramics, as well as combinations thereof. Additionally, or in the alternative, exemplary materials may include metals, ceramics, or binders, as well as combinations thereof. Exemplary ceramics may include ultra-high-temperature ceramics, and/or precursors for ultra-high-temperature ceramics, such as polymeric precursors. Each successive layer of powder material may be, for example, between about 10 μm and 200 μm, although the thickness may be determined based on any number of parameters and may be any suitable size.

As used herein, the term “build plane” refers to a plane defined by a surface upon which an energy beam impinges during an additive manufacturing process. Generally, the surface of a powder bed defines the build plane. During irradiation of a respective layer of the powder bed, a previously irradiated portion of the respective layer may define a portion of the build plane, and/or prior to distributing powder material across a build module, a build plate that supports the powder bed generally defines the build plane.

It is understood that terms “upstream” and “downstream” refer to the relative direction with respect to fluid flow in a fluid pathway. For example, “upstream” refers to the direction from which the fluid flows, and “downstream” refers to the direction to which the fluid flows. It is also understood that terms such as “top”, “bottom”, “outward”, “inward”, and the like are words of convenience and are not to be construed as limiting terms. As used herein, the terms “first”, “second”, and “third” may be used interchangeably to distinguish one component from another and are not intended to signify location or importance of the individual components. The terms “a” and “an” do not denote a limitation of quantity, but rather denote the presence of at least one of the referenced item.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

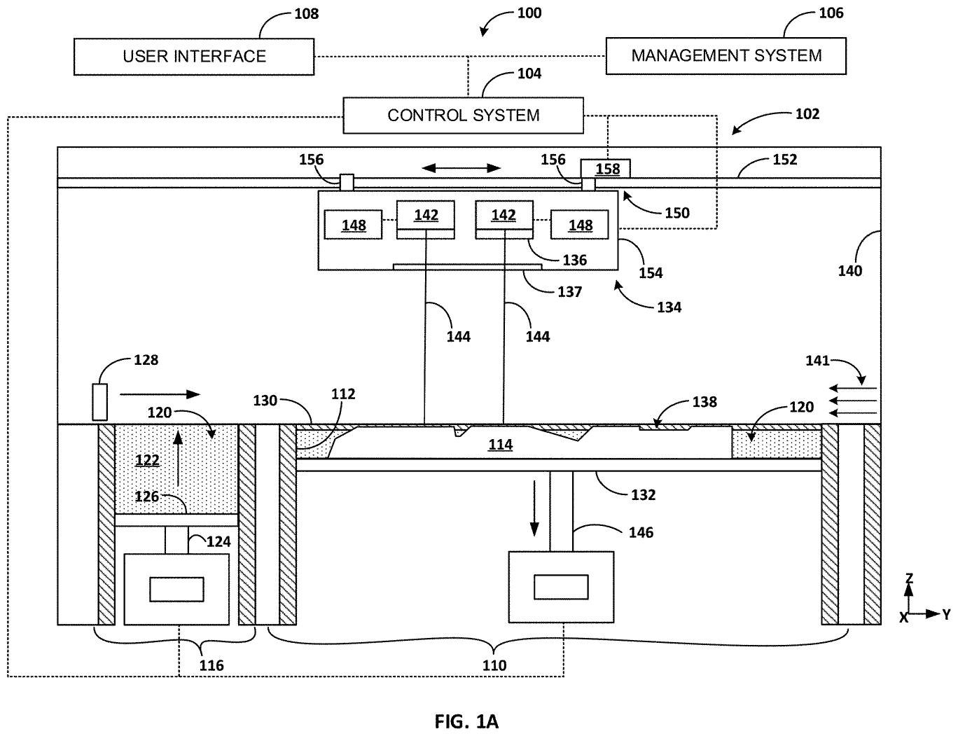

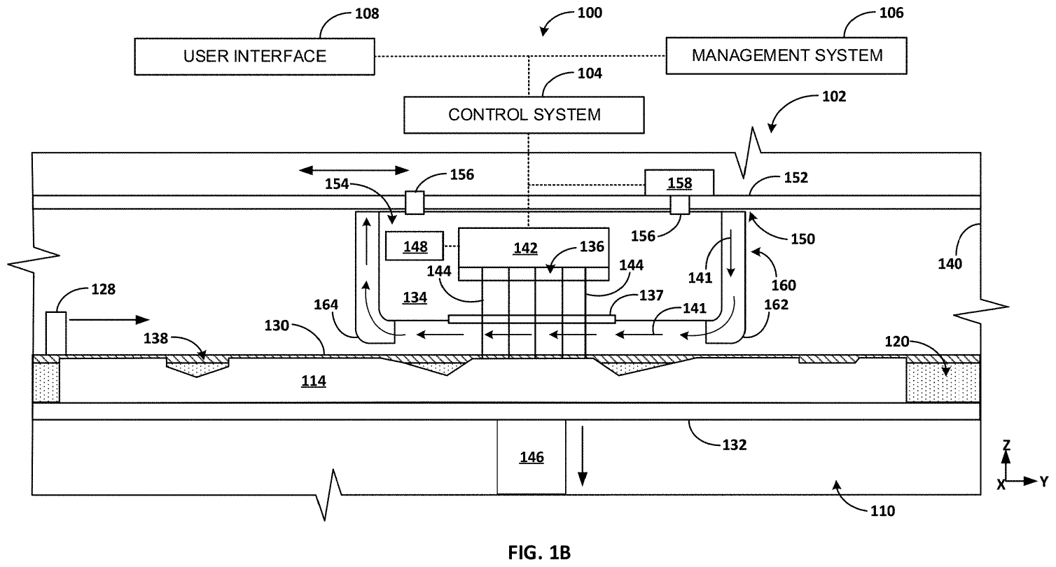

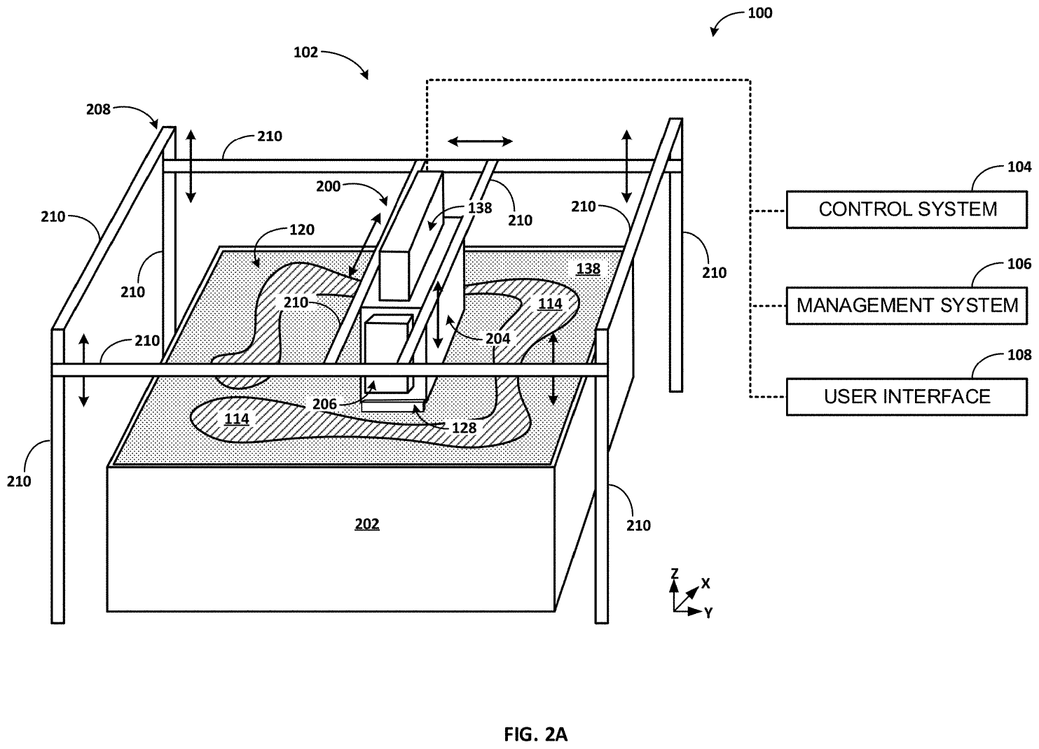

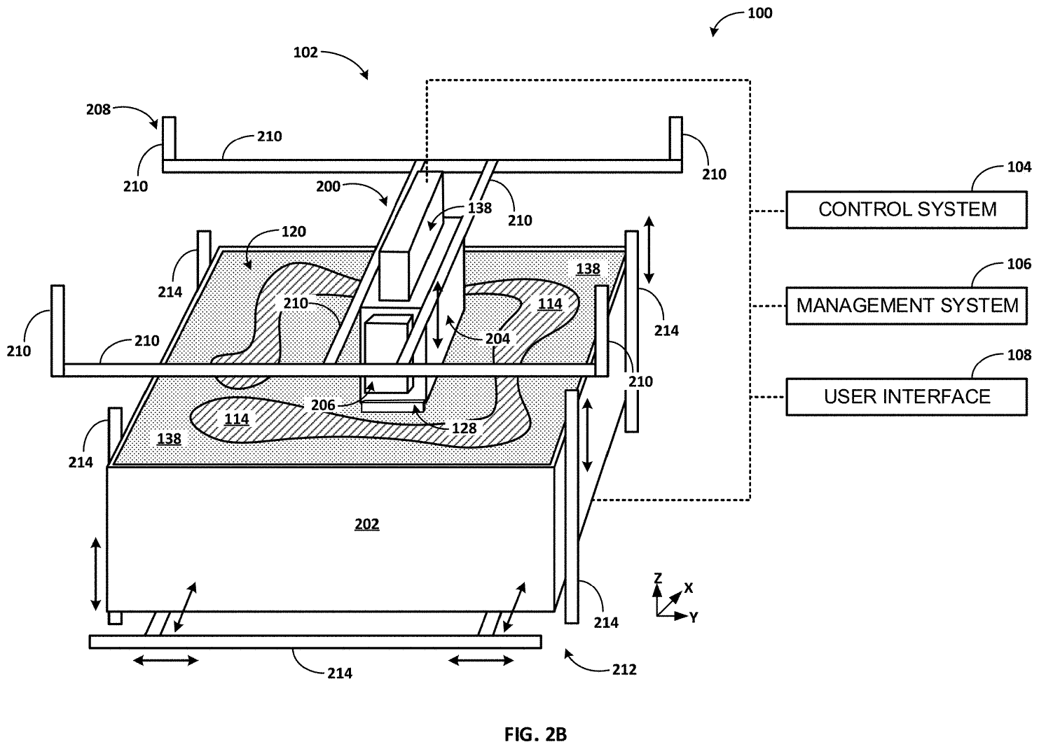

The presently disclosed subject matter will now be described in further detail. FIGS. 1A and 1B, and FIGS. 2A and 2B, schematically depict exemplary additive manufacturing systems 100. As shown, an additive manufacturing system 100 may include one or more additive manufacturing machines 102. It will be appreciated that the additive manufacturing systems 100 and machines 102 shown in FIGS. 1A and 1B, and FIGS. 2A and 2B, are provided by way of example and not to be limiting. In fact, the subject matter of the present disclosure may be practiced with any suitable additive manufacturing system 100 and machine 102 without departing from the scope of the present disclosure.

As shown, the one or more additive manufacturing machines 102 may include a control system 104. The control system 104 may be included as part of the additive manufacturing machine 102 or the control system 104 may be associated with the additive manufacturing machine 102. The control system 104 may include componentry integrated as part of the additive manufacturing machine 102 and/or componentry that is provided separately from the additive manufacturing machine 102. Various componentry of the control system 104 may be communicatively coupled to various componentry of the additive manufacturing machine 102.

The control system 104 may be communicatively coupled with a management system 106 and/or a user interface 108. The management system 106 may be configured to interact with the control system 104 in connection with enterprise-level operations pertaining to the additive manufacturing system 100. Such enterprise level operations may include transmitting data from the management system 106 to the control system 104 and/or transmitting data from the control system 104 to the management system 106. The user interface 108 may include one or more user input/output devices to allow a user to interact with the additive manufacturing system 100.

As shown, for example, in FIG. 1A, an additive manufacturing machine 102 may include a build module 110 that includes a build chamber 112 within which an object or objects 114 may be additively manufactured. An additive manufacturing machine 102 may include a powder module 116 that contains a supply of powder material 120 housed within a supply chamber 122. The build module 110 and/or the powder module 116 may be provided in the form of modular containers configured to be installed into and removed from the additive manufacturing machine 102 such as in an assembly-line process. Additionally, or in the alternative, the build module 110 and/or the powder module 116 may define a fixed componentry of the additive manufacturing machine 102. The powder module 116 may include a powder piston 124 that actuates a powder supply floor 126 during operation of the additive manufacturing machine 102. As the powder supply floor 126 actuates, a portion of the powder material 120 is forced out of the powder module 116. A recoater 128 such as a blade or roller sequentially distributes thin layers of powder material 120 across a build plane 130 above the build module 110. A build platform 132 supports the sequential layers of powder material 120 distributed across the build plane 130. A build platform 132 may include a build plate (not shown) secured thereto and upon which an object 114 may be additively manufactured.

As shown, for example, in FIGS. 1A and 1B, the additive manufacturing machine 102 may include an energy beam system 134 configured to generate one or more of energy beams and to direct the respective energy beams onto the build plane 130 to selectively solidify respective portions of the powder bed 138 defining the build plane 130. The energy beams may be laser beams or beams from any other suitable energy source, such as LEDs or other light sources, and so forth. As the respective energy beams selectively melt or fuse the sequential layers of powder material 120 that define the powder bed 138, the object 114 begins to take shape. The one or more energy beams or laser beams may include electromagnetic radiation having any suitable wavelength or wavelength range, such as a wavelength or wavelength range corresponding to infrared light, visible light, and/or ultraviolet light.

Typically, with a DMLM, EBM, or SLM system, the powder material 120 is fully melted, with respective layers being melted or re-melted with respective passes of the energy beams. With DMLS or SLS systems, typically the layers of powder material 120 are sintered, fusing particles of powder material 120 to one another generally without reaching the melting point of the powder material 120. The energy beam system 134 may include componentry integrated as part of the additive manufacturing machine 102 and/or componentry that is provided separately from the additive manufacturing machine 102.

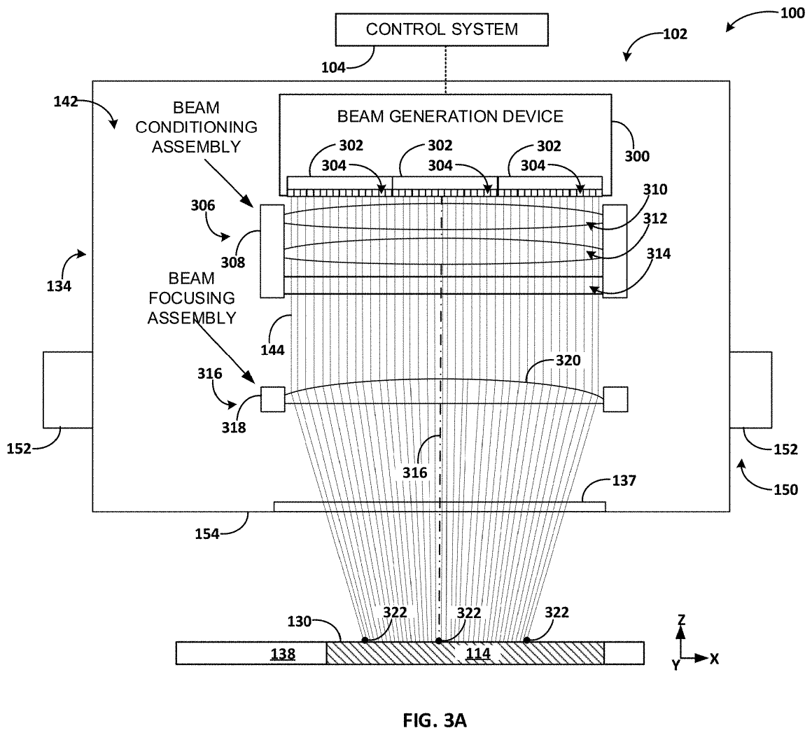

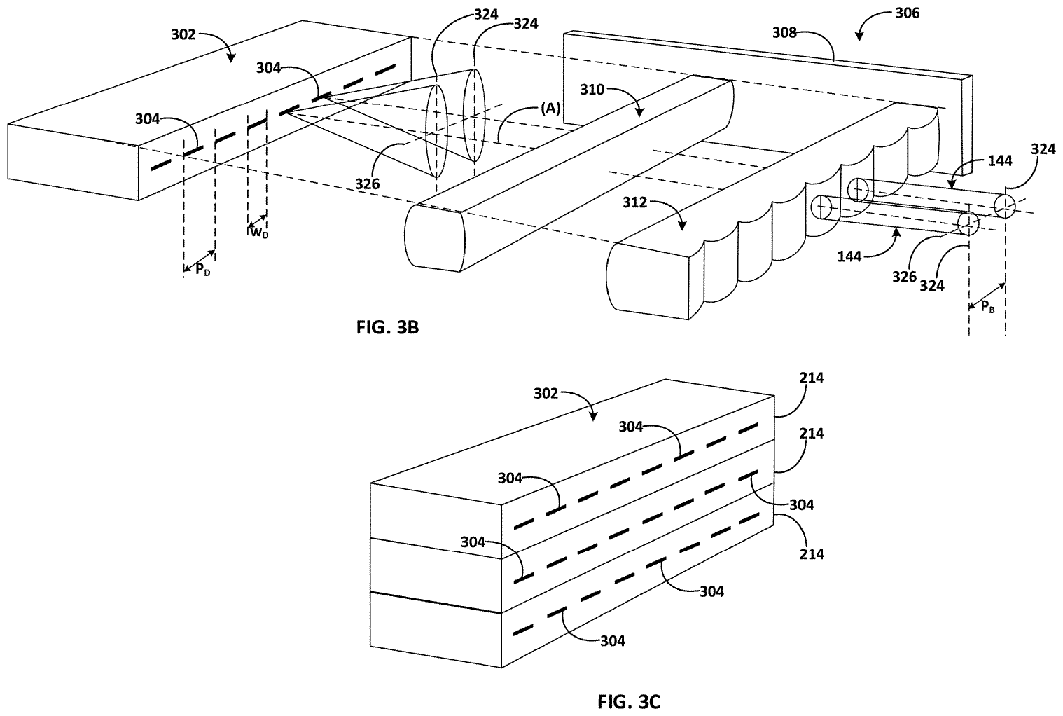

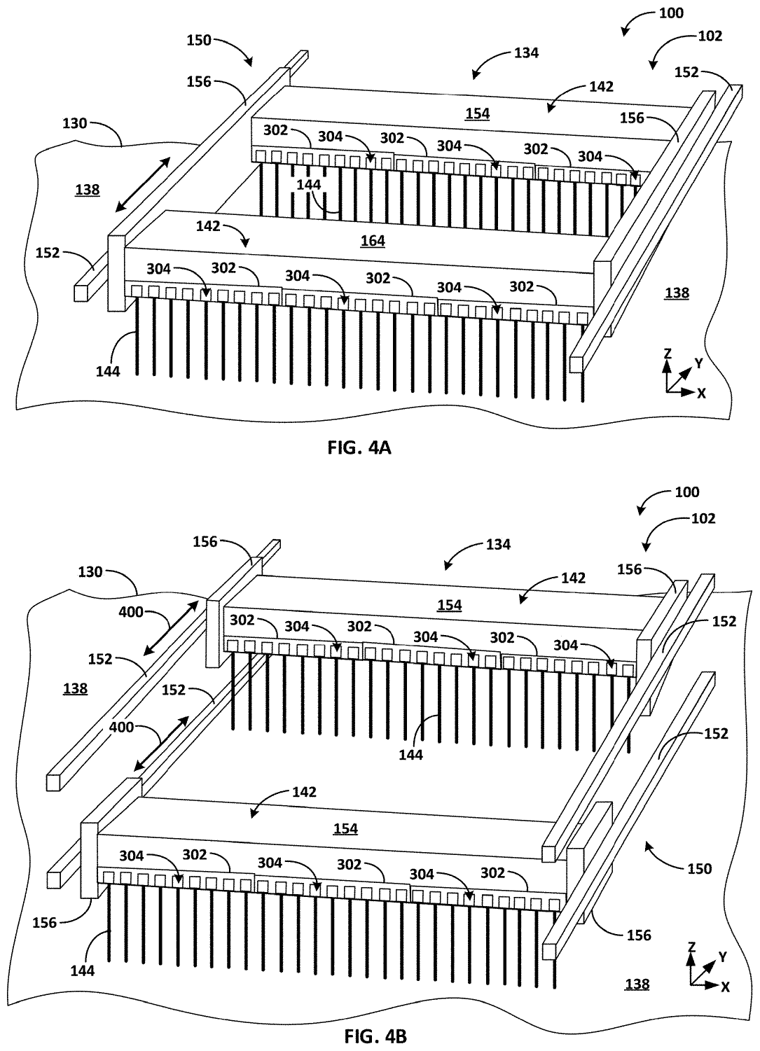

The energy beam system 134 may include one or more irradiation devices 142 configured to generate a plurality of energy beams 144 and to direct the energy beams 144 upon the build plane 130. As shown, for example, in FIG. 1A, an energy beam system 134 may include a plurality of irradiation devices 142, such as a first irradiation device 142 and a second irradiation device 142. The one or more irradiation devices may respectively include one or more laser diode arrays as further described below, for example, with reference to FIGS. 3A-3C, and FIGS. 4A and 4B. Additionally, or in the alternative, an energy beam system 134 may include three, four, six, eight, ten, or more diode arrays. The irradiation devices 142 may respectively include an energy beam source and an optical assembly. The optical assembly may include a plurality of optical elements 136 configured to direct the energy beam onto the build plane 130. By way of example, the one or more optical elements 136 may include one more focusing lenses configured to focus an energy beam 144 on a build plane 130. Additionally, or in the alternative, the energy beam system 134 may include a window 137, such as a protective glass, that separates one or more components of the energy beam system 134 from the environment of a process chamber 140 within which powder material 120 is irradiated by the one or more energy beams 144 to additively manufacture a three-dimensional object 114. A flow of inert process gas 141 may be supplied to the process chamber 140, for example, to remove contaminants such as fumes and soot from the process chamber 140 and/or to reduce the tendency of such contaminants to deposit on the on the window 137, optical elements 136, or other componentry of the energy beam system 134. Additionally, or in the alternative, the flow if inert process gas 141 may reduce the tendency of such contaminants to interfere with the energy beams 144 used to irradiate the powder material 120.

The plurality of energy beams 144 may become incident directly upon the build plane 130, for example, after passing through one or more optical elements 136 and/or a window 137 of the energy beam system 134. Additionally, or in the alternative, an irradiation device 142 may include a scanner configured to direct the plurality of energy beams 144 onto the powder bed 138. An exemplary scanner may include a galvo scanner, an electro-optic modulator, an acousto-optic modulator, a piezo-driven mirror, or the like. To irradiate a layer of the powder bed 138, the one or more irradiation devices 142 respectively direct the plurality of energy beams 144 across the respective portions of the build plane 130 to melt or fuse the portions of the powder material 120 that are to become part of the object 114. The sequential layers of the powder bed 138 are melted or fused to one another to additively manufacture the object 114. As sequential layers of the powder bed 138 are melted or fused to one another, a build piston 146 gradually moves the build platform 132 to make room for sequential layers of powder material 120. As the build piston 146 gradually lowers and sequential layers of powdered material 120 are applied across the build plane 130, the next sequential layer of powder material 120 defines the surface of the powder bed 138 coinciding with the build plane 130. Sequential layers of the powder bed 138 may be selectively melted or fused until a completed object 114 has been additively manufactured.

Still referring to FIGS. 1A and 1B, an additive manufacturing machine 102 may include an imaging system 148 configured to monitor one or more operating parameters of an additive manufacturing machine 102, one or more parameters of an energy beam system 134, and/or one or more operating parameters of an additive manufacturing process. The imaging system may include a calibration system configured to calibrate one or more operating parameters of an additive manufacturing machine 102 and/or of an additive manufacturing process. The imaging system 148 may be a melt pool monitoring system. The one or more operating parameters of the additive manufacturing process may include operating parameters associated with additively manufacturing a three-dimensional object 114. The imaging system 148 may be configured to detect an imaging beam such as an infrared beam from a laser diode and/or a reflected portion of an energy beam 144.

An energy beam system 134 and/or an imaging system 148 may include one or more detection devices. The one or more detection devices may be configured to determine one or more parameters of an energy beam system 134, such as one or more parameters associated with irradiating the sequential layers of the powder bed 138 based at least in part on an assessment beam detected by the imaging system 148. One or more parameters associated with irradiating the sequential layers of the powder bed 138 may include irradiation parameters and/or object parameters, such as melt pool monitoring parameters. The one or more parameters determined by the imaging system 148 may be utilized, for example, by the control system 104, to control one or more operations of the additive manufacturing machine 102 and/or of the additive manufacturing system 100. The one or more detection devices may be configured to obtain assessment data of the build plane 130 from a respective assessment beam. An exemplary detection device may include a camera, an image sensor, a photo diode assembly, or the like. For example, a detection device may include charge-coupled device (e.g., a CCD sensor), an active-pixel sensor (e.g., a CMOS sensor), a quanta image device (e.g., a QIS sensor), or the like. A detection device may additionally include a lens assembly configured to focus an assessment beam along a beam path to the detection device. An imaging system 148 may include one or more imaging optical elements (not shown), such as mirrors, beam splitters, lenses, and the like, configured to direct an assessment beam to a corresponding detection device.

In addition, or in the alternative to determining parameters associated with irradiation the sequential layers of the powder bed 138, the imaging system 148 may be configured to perform one or more calibration operations associated with an additive manufacturing machine 102, such as a calibration operation associated with the energy beam system 134, one or more irradiation devices 142 or components thereof, and/or the imaging system 148 or components thereof. The imaging system 148 may be configured to project an assessment beam and to detect a portion of the assessment beam reflected from the build plane 130. The assessment beam may be projected by an irradiation device 142 and/or a separate beam source associated with the imaging system 148. Additionally, and/or in the alternative, the imaging system 148 may be configured to detect an assessment beam that includes radiation emitted from the build plane 130, such as radiation from an energy beam 144 reflected from the powder bed 138 and/or radiation emitted from a melt pool in the powder bed 138 generated by an energy beam 144 and/or radiation emitted from a portion of the powder bed 138 adjacent to the melt pool. The imaging system 148 may include componentry integrated as part of the additive manufacturing machine 102 and/or componentry that is provided separately from the additive manufacturing machine 102. For example, the imaging system 148 may include componentry integrated as part of the energy beam system 134. Additionally, or in the alternative, the imaging system 148 may include separate componentry, such as in the form of an assembly, that can be installed as part of the energy beam system 134 and/or as part of the additive manufacturing machine 102.

Still referring to FIGS. 1A and 1B, in some embodiments, an additive manufacturing machine may include a positioning system 150 configured to move an energy beam system 134 and/or one or more components thereof relative to the build plane 130. The positioning system 150 may be configured to move the energy beam system 134 and/or one or more components thereof to specified build coordinates and/or along specified build vectors corresponding to a cartesian coordinate system in accordance with control commands provided, for example, by the control system 104.

The control commands may be provided, for example, to carry out operations of the one or more energy beam system 134 and/or of the additive manufacturing machine 102 in accordance with the present disclosure. The positioning system 150 may include one or more gantry elements 152 configured to move the energy beam system 134 and/or one or more components thereof across the powder bed 138. Respective gantry elements 152 may be configured to move the energy beam system 134 and/or one or more components thereof in one or more directions, such as an X-direction, a Y-direction, and/or a Z-direction. In some embodiments, the positioning system 150 may be coupled to a housing assembly 154 that contains one or more components of the energy beam system 134, such as one or more irradiation devices 142 and or one or more imaging systems 148. The housing assembly 154 may be coupled to one or more gantry elements 152 by one or more gantry mounts 156. The positioning system 150 may include a drive motor 158 configured to move the housing assembly 154 and/or the one or more components the energy beam system 134 according to instructions for the control system 104. The positioning system 150 may include componentry typically associated with a gantry system, such as stepper motors, drive elements, carriages, and so forth.

The energy beam system 134 may be positioned at any suitable location within the process chamber 140. Additionally, or in the alternative, the energy beam system 134 may be coupled to a perimeter wall of the process chamber 140. In some embodiments, as shown, for example, in FIG. 1B, an energy beam system 134 may be positioned in close proximity to the build plane 130. As shown in FIG. 1B, an inertization system 160 may supply a flow of inert process gas 141 to a region of the process chamber 140 between the energy beam system 134 and the powder bed 138. The inertization system 160 may include a supply manifold 162 and a return manifold 164. As shown in FIG. 1B, the supply manifold 162 and/or the return manifold 164 may be coupled to the housing assembly 154. With the supply manifold 162 and/or the return manifold 164 coupled to the housing assembly 154, a relatively small volume of space between the energy beam system 134 and the powder bed 138 may be inertized, as opposed to inertizing an entire process chamber 140. Additionally, or in the alternative, contaminants may have a shorter path to travel before being drawn into the return manifold 164 by the flow of inert process gas 141.

Referring now to FIGS. 2A and 2B, an additive manufacturing system 100 or additive manufacturing machine 102 may include one or more build units 200 configured to selectively solidify powder material 120 to additively manufacture a three-dimensional object 114. In some embodiments, the additive manufacturing system 100 or additive manufacturing machine 102 may be configured for large format additive manufacturing. For example, one or more build units 200 may be configured to irradiate a powder bed 138 supported by a build vessel 202 that includes a cross-sectional area that exceeds the cross-sectional area of the one or more build units 200. Likewise, an object 114 additively manufactured with the additive manufacturing machine 102 may have a cross-sectional area that is larger than the one or more build units 200. The one or more build units 200 and/or the build vessel 202 may be movable relative to one another, for example, to perform large-format additive manufacturing operations.

As shown in FIGS. 2A and 2B, an exemplary build unit 200 may include an energy beam system 134 and an irradiation chamber 204. The build unit 200 may be configured to irradiate powder material 120 within a region of the powder bed 138 coinciding the perimeter of the irradiation chamber 204. The one or more build units 200 may be movable relative to the build vessel 202, and/or the build vessel 202 may be movable relative to one or more build units 200. For example, a build unit 200 and/or a build vessel 202 may be movable in one or more directions, such as an X-direction, a Y-direction, and/or a Z-direction. Movement of a build unit 200 relative to the build vessel 202 may be configured to allow the build unit 200 to access various regions of the powder bed 138 so that the energy beam system 134 may irradiate powder material 120 in respective regions. The energy beam system 134 may be configured as described with reference to FIG. 1A. The energy beam system 134 may include one or more irradiation devices 142 and/or other components as described herein. The irradiation chamber 204 may be configured to provide an inert environment for irradiating the powder bed 138. A flow of inert process gas 141 may be supplied to the irradiation chamber 204, for example, to remove contaminants such as fumes and soot from the irradiation chamber 204 and/or to reduce the tendency of such contaminants to deposit on the on the window 137, optical elements 136, or other componentry of the energy beam system 134. Additionally, or in the alternative, the flow if inert process gas 141 may reduce the tendency of such contaminants to interfere with the energy beams 144 used to irradiate the powder material 120. In some embodiments, a build unit 200 may include a powder supply hopper 206 configured to supply powder material 120 to a build vessel 202. A recoater 128 may spread the powder material 120 across at least a portion of the build plane 130 coinciding with a perimeter of the build unit 200. Additionally, or in the alternative, powder material 120 may be supplied by a powder module 116 as described with reference to FIG. 1A.

As shown in FIG. 2A, the one or more build units 200 may be operably coupled to a build unit-positioning system 208. The build unit-positioning system 208 may be configured to move the one or more build units 200 to specified build coordinates and/or along specified build vectors corresponding to a three-dimensional cartesian coordinate system in accordance with control commands provided, for example, by the control system 104. The control commands may be provided, for example, to carry out operations of the one or more build units 200 and/or the respective components thereof. The build unit-positioning system 208 may include one or more build unit-gantry elements 210 configured to movably support the one or more build units 200. The build unit-gantry elements 210 may include componentry typically associated with a gantry system, such as stepper motors, drive elements, carriages, and so forth. Respective build unit-gantry elements 210 may be configured to move the one or more build units 200 in one or more directions, such as an X-direction, a Y-direction, and/or a Z-direction.

As shown in FIG. 2B, the one or more build vessels 202 may be operably coupled to a build vessel-positioning system 212. The build vessel-positioning system 212 may be configured to move the build vessel 202 to specified build coordinates and/or along specified build vectors corresponding to a three-dimensional cartesian coordinate system in accordance with control commands provided, for example, by the control system 104. The control commands may be provided, for example, to carry out operations of the one or more build units 200 in accordance with the present disclosure. The build vessel-positioning system 212 may include one or more build vessel-gantry elements 214 configured to movably support the build vessel 202. Respective build vessel-gantry elements 214 may be configured to move the build vessel 202 in one or more directions, such as an X-direction, a Y-direction, and/or a Z-direction.

The one or more build vessels 212 may be operably coupled to a build vessel-positioning system 212 in addition to, or in the alternative to, one or more build units 200 operably coupled to a build unit-positioning system 208. For example, an additive manufacturing machine 102 may include a build vessel-positioning system 212 and one or more stationary build units 200. Additionally, or in the alternative, an additive manufacturing machine 102 may include a build vessel-positioning system 212 and a build unit-positioning system 208. The build vessel-positioning system 212 may be configured to move a build vessel 202 in one or more directions, and the build vessel-positioning system 212 may be configured to move a build vessel 202 in one or more directions. For example, the build vessel-positioning system 212 may be configured to move a build vessel 202 in an X-direction and/or a Y-direction. Additionally, or in the alternative, the build unit-positioning system 208 may be configured to move a build unit 200 in a Z-direction.

A build vessel-positioning system 212 may be configured to move a build vessel 202 horizontally while one or more build units 200 selectively irradiate portions of the powder material 120 in the build vessel 202. For example, the build vessel-positioning system 212 may be configured to move a build vessel 202 in accordance with an X-Y coordinate system. Additionally, or in the alternative, a build unit-positioning system 208 may be configured to move a build unit 200 horizontally while the build unit 200 selectively irradiates portions of the powder material 120 in the build vessel 202. For example, the build vessel-positioning system 212 may be configured to move a build vessel 202 in accordance with an X-Y coordinate system. A vertical position of the one or more build units 200 and/or the build vessel 202 may be augmented in connection with the addition of sequential layers of powder material 120 to the build vessel 202 and selective irradiation of the respective layers of powder material 120 in the build vessel 202. The build vessel-positioning system 212 may be configured to sequentially move the build vessel 202 vertically to provide room for the next sequential layer of powder material 120 to be added to the build vessel 202. Additionally, or in the alternative, the build unit-positioning system 208 may be configured to sequentially move a build unit 200 vertically to provide room for the next sequential layer of powder material 120 to be added to the build vessel 202. Movements of the build unit 200 and/or the build vessel 202 may be carried out before, during, or after, irradiating a sequential layer of powder material 120.

Referring now to FIGS. 3A-3C, exemplary irradiation devices are further described. As shown in FIG. 3A, an exemplary irradiation device 142 may include a beam generation device 300. The beam generation device 300 may include a plurality of laser diode arrays 302. The respective laser diode arrays 302 may include a plurality of diode emitters 304. The plurality of diode emitters 304 may be respectively configured to emit an energy beam 144. The respective laser diode arrays 302 may be configured to emit energy beams horizontally or vertically relative to the laser diode array 302. A laser diode array 302 that emits energy beams horizontally may sometimes be referred to as an edge-emitting laser diode array. By way of example, exemplary edge-emitting laser diode arrays may include double heterostructure laser diodes, quantum well laser diodes, separate confinement heterostructure laser diodes, separate confinement heterostructure quantum well laser diodes, distributed Bragg reflector laser diodes, distributed feedback laser diodes, and so forth. Exemplary laser diode arrays 302 that emit energy beams vertically may include vertical cavity surface-emitting laser diodes (VCSELs), vertical external cavity surface-emitting laser diodes (VECSELs), Bragg reflector laser diodes, and so forth.

The irradiation device may include a beam conditioning assembly 306. The beam conditioning assembly 306 may be disposed downstream from the beam generation device 300. The beam conditioning assembly 306 may include a conditioning housing 308 configured to support one or more optical elements configured to focus and/or otherwise condition the energy beams 144 emitted by the diode emitters 304. In some embodiments, the beam conditioning assembly 306 may include one or more collimating lenses. For example, as shown, the beam conditioning assembly 306 may include a fast-axis collimating lens 310 and/or a slow-axis collimating lens 312. The fast-axis collimating lens 310 and the slow-axis collimating lens 312 may be provided as separate optical elements or respective portions of a common optical element. In some embodiments, the fast-axis collimating lens 310 and/or the slow-axis collimating lens 312 may be configured as a microlens array.

In some embodiments, the beam conditioning assembly 306 may include a beam homogenizer 314, for example, disposed downstream from the one or more collimating lenses. An exemplary beam homogenizer 314 may include one or more microlens arrays in front of a condenser lens. The beam homogenizer 314 may be configured to provide a uniform power distribution with respect to a cross-sectional profile of respective ones of the plurality of energy beams 144 and/or with respect to the plurality of energy beams 144 as a group. For example, an energy beam 144 may have a Gaussian power distribution as emitted by a laser diode and/or after having been collimated. In some embodiments, the beam homogenizer 314 may be configured to provide a top-hat power distribution. Additionally, or in the alternative, the beam homogenizer 314 may be configured to provide a plurality of energy beams 144 that have a substantially uniform intensity and/or powder level. Additionally, or in the alternative, the beam homogenizer may be configured to correct smile error across a plurality of energy beams 144 collimated by one or more collimating lenses of the beam conditioning assembly 306. For example, the beam homogenizer may include individually addressable optical elements, such as lenses or mirrors, configured to adjust respective ones of the plurality energy beams 144 to provide a plurality of energy beams 144 that have a coplanar orientation and/or a common optical plane.

An irradiation device 142 may include a beam focusing assembly 316 disposed downstream from the beam conditioning assembly 306. The beam focusing assembly 316 may include a focusing housing 318 configured to support one or more focusing lenses 320. An exemplary focusing lens 320 may include a cylindrical plano-convex lens. In some embodiments, a beam focusing assembly 316 may include a fast-axis focusing lens, such as a fast-axis plano-convex lens. Additionally, or in the alternative, a beam focusing assembly 316 may include a slow-axis focusing lens, such as a slow-axis plano-convex lens.

The irradiation device 142 may include any one or more other optical elements that may be suitable for the particular embodiment. For example, the irradiation device 142 may include one or more dichroic elements, such as dichroic mirror, configured to split a measurement beam from one or more of the plurality of energy beams 144.

The plurality of energy beams 144 emitted by the respective diode emitters 304 of the plurality of diode arrays 302 may respectively become incident upon the build plane 130 in the form of a beam spot 322. A plurality of beam spots 322 corresponding to respective ones of the plurality of energy beams 144 may become incident upon the build plane 130 in the form of a pattern, such as a linear or curvilinear pattern of beam spots 322. Respective beam spots 322 may be adjacent to one another and/or partially overlapping with one another.

FIGS. 3B and 3C show exemplary laser diode array 302 that includes a plurality of diode emitters 304. As shown in FIG. 3B, a laser diode array 302 may include a one-dimensional array of diode emitters 304. As shown in FIG. 3C, a laser diode array 302 may include a two-dimensional array of diode emitters 304. The diode emitters 304 may be spaced apart by a diode pitch ( of from about 25 micrometers (μm) to about 250 μm, such as from about 50 μm to about 100 μm, or such as from about 100 μm to about 150 μm. In some embodiments, as shown, the respective energy beams may exhibit an elliptical cross-sectional profile. Additionally, or in the alternative, the respective energy beams may exhibit a circular cross-sectional profile. Generally, an edge-emitting laser diode tends to exhibit an elliptical cross-sectional profile. Generally, a vertical cavity surface-emitting laser tends to exhibit a circular cross-sectional profile. An energy beam 144 emitted from a diode emitter 304 may expand with respect to a fast-axis 324 and/or with respect to a slow-axis 326, for example, resulting in an elliptical cross-sectional profile. The fast-axis collimating lens 310 may collimate the energy beams 144 with respect to the fast-axis 324. The slow-axis collimating lens 312 may collimate the energy beams 144 with respect to the slow-axis 326.

The one or more lenses of the beam conditioning assembly 306 may be configured and arranged to provide an array of energy beams 144 that are spaced apart from one another by a beam pitch (P_{B}). The one or more lenses of the beam conditioning assembly 306 may be configured and arranged to provide an array of energy beams 144 with a beam pitch (P_{B}) between adjacent energy beams 144 suitable for providing an alternating pattern or sequence of beam spots 322. The alternating pattern or sequence of beam spots 322 may be provided by a plurality of laser diode arrays 302. The plurality of laser diode arrays 302 may be configured and arranged with a suitable space between adjacent energy beams 144 to provide the alternating pattern or sequence of beam spots 322. The alternating pattern or sequence of beam spots 322 may provide a beam pitch (P_{B}) that is less than or equal to the diode pitch ( of the respective laser diode arrays 302. For example, one or more optical elements of the beam conditioning assembly 306 and/or the beam focusing assembly 316 (FIG. 3A) may focus the respective energy beams 144 so as to reduce the beam pitch (P_{B}) relative to the diode pitch (. In some embodiments the beam pitch beam pitch (P_{B}) may be from about 10% to about 100% of the diode pitch (P_{D}), such as from about 25% to about 50% of the diode pitch (P_{D}), or such as from about 50% to about 95% of the diode pitch (P_{D).}

The space between adjacent energy beams 144 and/or adjacent beam spots 322 may be determined based at least in part on the diode pitch (P_{D}) of the diode emitters 304 and the width (wD) of the diode emitters 304. As shown in FIG. 3B, in some embodiments, the respective energy beams 144 may expand from the respective diode emitters 304 with respect to a fast-axis 324 and/or with respect to a slow-axis 326. The expansion of the beam may be described with reference to a Lagrange invariant (L), according to the following relationship: L=NA×w_{D}/2, where NA is the numerical aperture, and (wD) is the width of the diode emitter 304. The numerical aperture may be from about 0.1 to about 0.6, such as from about 0.1 to about 0.2, or such as from about 0.3 to about 0.5. The diode width may be from about 50 micrometers (μm) to about 300 μm, such as from about 100 μm to about 250 μm, such as from about such as from about 100 μm to about 200 μm. The Lagrange invariant may be from about 2.5 μm to about 90 μm, such as from about 5μm to about 25 μm, such as from about 5μm to about 10 μm, or such as from about 10 μm to about 20 μm.

A cross-sectional dimension of respective ones of the plurality of beam spots 322 and/or energy beams 144 may be determined based at least in part on the Lagrange invariant. The one or more lenses of the beam conditioning assembly 306 may be configured to collimate and/or otherwise condition the respective energy beams such that the beam spots may become incident upon the powder bed 138 with suitable spacing to allow for the alternating pattern or sequence of beam spots 322. The respective beam spots 322 in the alternating pattern may be provided by respective ones of a plurality of laser diode arrays 302 and/or by respective ones of a plurality of irradiation devices 142.

In some embodiments, an alternating pattern of beam spots 322 may be suitable for additively manufacturing three-dimensional objects with high quality requirement when the respective energy beams 144 exhibit good beam quality. The quality of an energy beam 144 may be influenced by any one or more of a plurality of quality parameters, such as beam profile, waist position, intensity, caustic, spot size, and/or focal length, as well as combinations of these. The quality of an energy beam 144 may be described with reference to a beam quality factor (M²) according to ISO Standard 11146. The beam quality factor (M²) represents a variation of a beam from a diffraction-limited Gaussian beam with the same wavelength. The beam quality factor (M²) may be described according to the following relationship:

$$θ = {M}^{2} \frac{λ}{π {W}_{0}} ,$$

where (θ) is the half-angle beam divergence, (W₀) is the beam radius at the beam waist, (λ) is the wavelength. A diffraction-limited Gaussian beam has an M² value of 1.0. In some embodiments, the presently disclosed energy beam systems 134, irradiation devices 142, and/or methods may utilize an energy beam 144 with an M² value of from about 1.05 to about 2.0, such as from about 1.05 to about 1.5, such as from about 1.05 to about 1.2, or such as from about 1.05 to about 1.15.

As shown in FIGS. 4A and 4B, an energy beam system may include a plurality of irradiation devices 142 mounted to a positioning system 150 configured to move the plurality of irradiation devices 142 relative to the build plane 130. The plurality of irradiation devices 142 may be respectively coupled to one or more gantry elements 152 by one or more gantry mounts 156. As shown in FIG. 3A, a gantry mount 156 may support a plurality of irradiation devices 142, for example, such that the plurality of irradiation devices 142 may be moveable relative to the build plane 130 as a common assembly. Additionally, or in the alternative, as shown in FIG. 3B, a plurality of irradiation devices may be separately supported by respective gantry mounts 156, for example, such that the respective irradiation devices 142 may be independently moveable relative to the build plane 130. A plurality of energy beams 144 emitted by the plurality of irradiation devices 142 may propagate across the build plane 130 in an irradiation direction 400 by way of relative motion between the plurality of irradiation devices 142 and the build plane 130. For example, the relative movement may be provided by the positioning system 150. The plurality of irradiation devices 142 and/or the plurality of energy beams 144 from the plurality of irradiation devices 142 may propagate across the powder bed 138 at a rate of from about 1 millimeters-per-second (mm/s) to about 10 mm/s, such as from about 2 mm/s to about 5 mm/s, or such as from about 5 mm/s to about 10 mm/s.

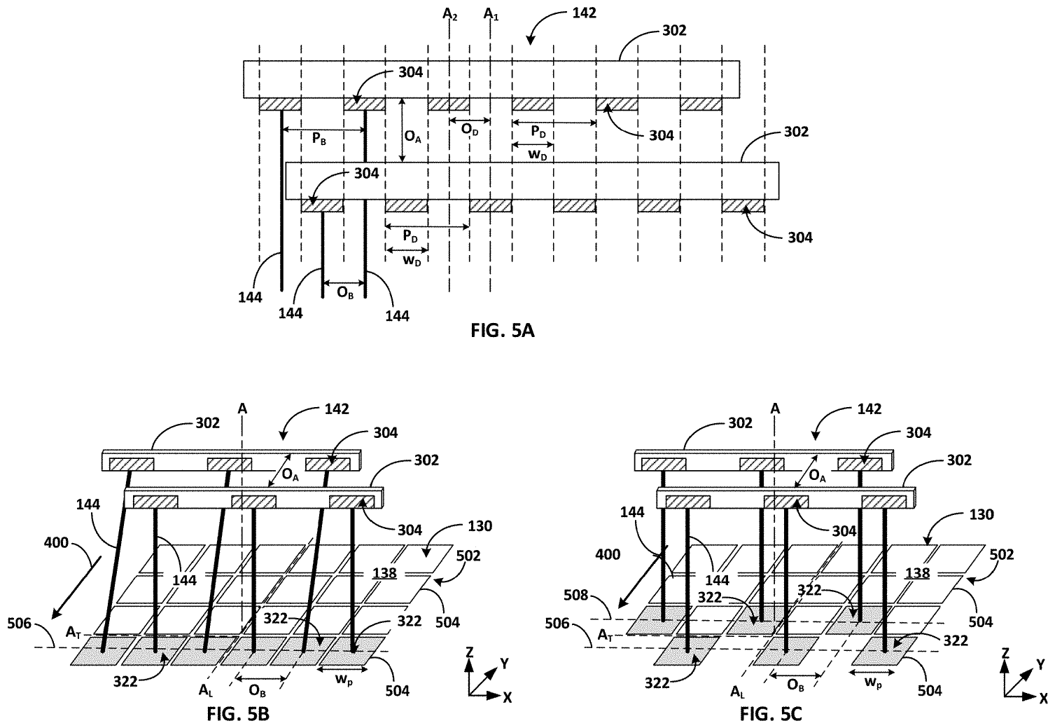

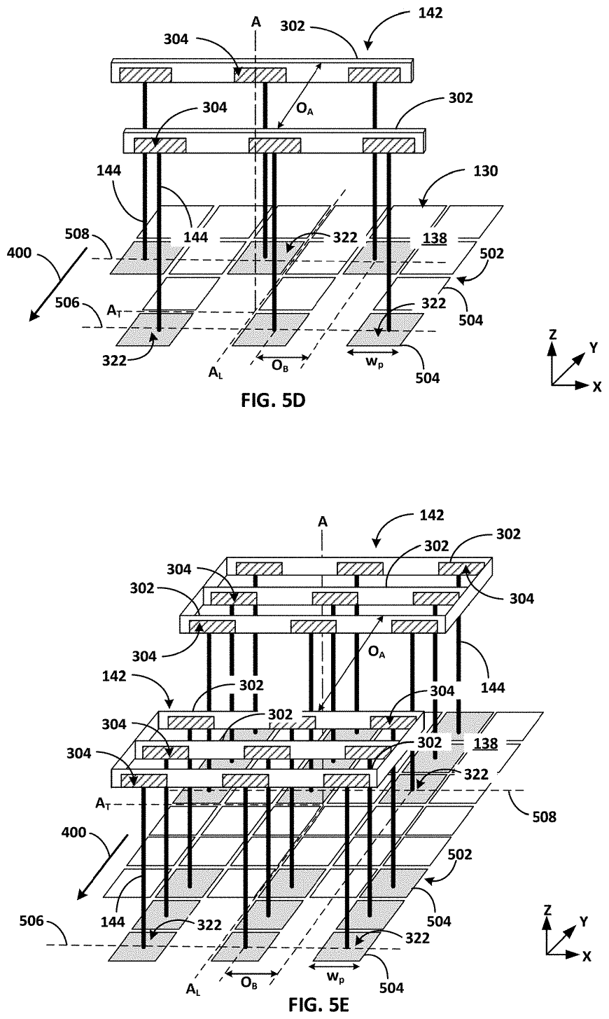

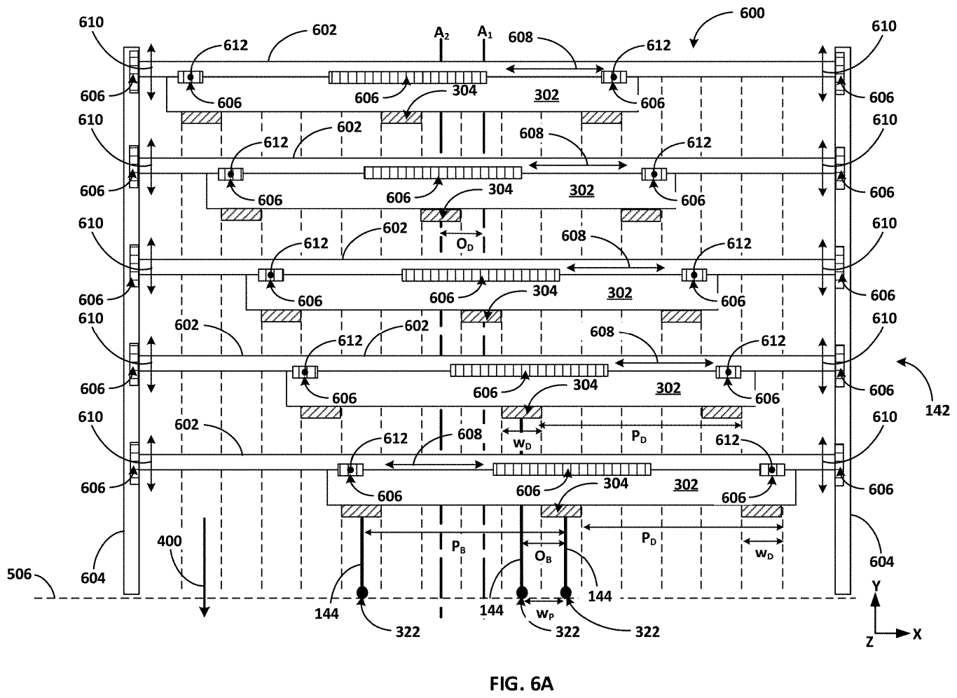

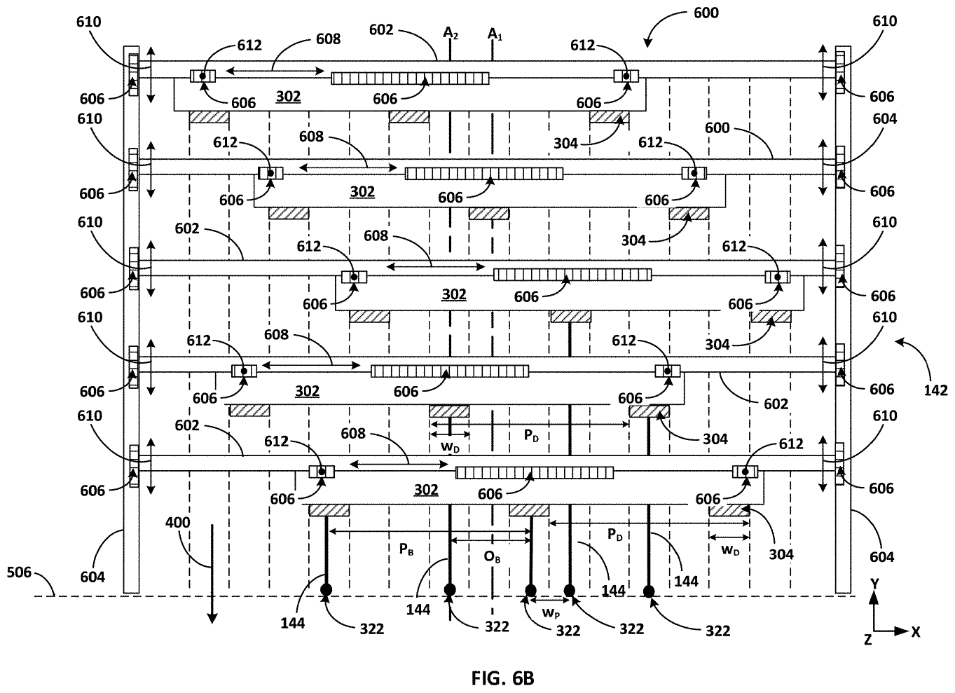

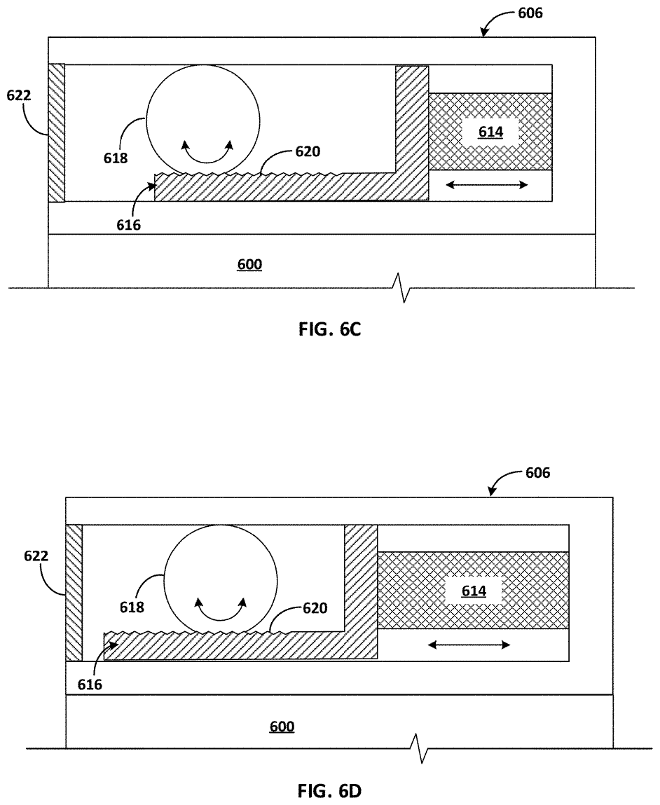

Referring now to FIGS. 5A-5E, and FIGS. 6A and 6B, exemplary configurations and arrangements of laser diode arrays 302 are described. The laser diode arrays 302 may include a plurality of diode emitters 304 that emit a plurality of energy beams 144, and the plurality of energy beams 144 may provide a corresponding plurality of beam spots 322 upon a build array 502 defined by the powder bed 138. The beam spots 322 may become incident upon respective build points 504 of the build array 502 as the beam spots 322 propagate across the powder bed 138 in an irradiation direction 400. The configurations and arrangements shown in FIGS. 5A-5E may provide improved thermal interactions throughout the build array 502, such as between adjacent build points 504 of the build array 502, for example, as heat conduction from adjacent build points 504 propagates across the powder bed 138. The configurations and arrangements shown in FIGS. 5A-5E, and FIGS. 6A and 6B, may provide for a pattern or sequence of beam spots 322 that includes adjacent beams spots 322 that are longitudinally offset from one another with reference to a longitudinal axis (A_{L}) of the build array 502, such as in an alternating pattern or sequence. The alternating pattern or sequence of beam spots 322 may include beam spots that are located longitudinally forward relative to adjacent beam spots 322 and/or beam spots that are located longitudinally aft relative to adjacent beam spots 322. The longitudinal axis (A_{L}) may be parallel to an irradiation direction 400. The longitudinal offset between adjacent beam spots 322 may provide a linear scan field that includes a first plurality of beam spots 322 laterally spaced apart from one another followed by a second plurality of beam spots 322 laterally spaced apart from one another and longitudinally offset from the first plurality of beam spots 322 with reference to a longitudinal axis (A_{L}). Additionally, or in the alternative, the first plurality of beam spots 322 and the second plurality of beam spots 322 may be laterally offset from one another, for example, with reference to a transverse axis (A_{T}) of the build array 502. The transverse axis (A_{T}) may be perpendicular to an irradiation direction 400. The lateral offset may be selected to position the second plurality of beam spots 322 to fill-in spaces between hatches formed by the first plurality of beam spots 322 as the respective energy beams 144 propagate across the build array 502 in the irradiation direction 400.

The second plurality of beam spots 322 may be longitudinally offset from the first plurality of beam spots 322 with respect to a distance and/or a time delay suitable to reduce the tendency for adjacent build points 504 to introduce thermal variability, thereby allowing for a more uniform power density and/or improved controllability of the power density at the respective build points 504. For example, a first row of beam spots 322 may propagate across the powder bed 138 with a suitable lateral space between them, followed by a second row of beam spots 322 with a suitable space lateral between them and laterally offset from the first row of beam spots 322. The first row of beam spots 322 may scan a corresponding plurality of first hatch lines across the powder bed 138. The second row of beam spots 322 may scan a corresponding second plurality of hatch lines across the powder bed 138. The lateral offset between the first and second row of beam spots 322 may be configured and arranged such that the second plurality of hatch lines fill in the spaces between adjacent one of the first plurality of hatch lines resulting from the first plurality of beam spots 322 being scanned across the powder bed 138 ahead of the second plurality of beam spots 322.

As shown, for example, in FIG. 5A, an exemplary irradiation device 142 may include a plurality of laser diode arrays 302. The plurality of laser diode arrays 302 may respectively have an optical axis (A). The optical axis (A) may be defined by a point of reference of the laser diode array 302 and oriented normal to a direction of emission of one or more energy beams 144 emitted by a diode emitter 304 of the respective laser diode array 302. In some embodiments, the point of reference may be a centrally located diode emitter 304. A plurality of laser diode arrays 302 may be longitudinally offset relative to one another, for example, by an array offset distance (O_{A}). The array offset distance (O_{A}) may be determined with reference to a longitudinal axis (A_{L}). The array offset (O_{A}) may be selected with respect to a distance and/or a time delay between longitudinally adjacent laser diode arrays 302 suitable to provide longitudinal separation as between a first plurality of beam spots 322 corresponding to a first laser diode array 302 and a second plurality of beam spots 322 corresponding to a second laser diode array 302 that is longitudinally adjacent to the first laser diode array 302, for example, to reduce the tendency for adjacent build points 504 to introduce thermal variability. For embodiments that include more than two laser diode arrays, such as at least three laser diode arrays, the array offset distance (O_{A}) may be uniform as between respective ones of the plurality of laser diode arrays, or the array offset distance (O_{A}) may differ as between respective ones of the plurality of laser diode arrays. Additionally, or in the alternative, a plurality of laser diode arrays 302 may be laterally offset relative to one another, for example, by a diode offset distance (O_{D}). The diode offset distance (O_{D}) may be determined with reference to a transverse axis (A_{T}). The diode offset distance (O_{D}) may include a lateral offset relative to the optical axis (A). For embodiments that include more than two laser diode arrays, such as at least three laser diode arrays, the diode offset distance (O_{D}) may be uniform as between respective ones of the plurality of laser diode arrays, or the diode offset distance (O_{D}) may differ as between respective ones of the plurality of laser diode arrays.

The diode offset distance (O_{D}) between respective laser diode arrays 302 may provide a beam offset distance (O_{B}) with respect to energy beams 144 emitted by the respective diode emitters 304. The beam offset distance (O_{B}) may be determined with reference to a transverse axis (A_{T}). The beam offset distance (O_{B}) may include a lateral beam offset. For example, the irradiation device 142 may include a first laser diode array 302 and a second laser diode array 302 oriented relative to an optical axis (A) with a diode offset distance (O_{D}) relative to one another. The diode offset distance (O_{D}) between the first and second laser diode array 302 may be determined relative to the optical axis (A) and/or relative to respective diode emitters 304. The diode offset distance (O_{D}) between the first and second laser diode array 302 may be configured to provide a corresponding beam offset distance (O_{B}) between respective energy beams 144 emitted by a first diode emitter 304 of the first laser diode array 302 and a second diode emitter 304 emitted by the second laser diode array 302. For example, a first laser diode array 302 may emit a first plurality of energy beams 144 and a second laser diode array may emit a second plurality of energy beams 144, and respective ones of the first plurality of energy beams 144 may be laterally offset from respective ones of the second plurality of energy beams 144 by a beam offset distance (O_{B}) determined with reference to a transverse axis (A_{T}) of the build array. A beam offset distance (O_{B}) between a first energy beam 144 corresponding to the first laser diode array 302 and a second energy beam 144 corresponding to a second laser diode array 302 may be oriented perpendicular to an irradiation direction 400 of the irradiation device 142 relative to the build plane 130.

A diode offset distance (O_{D}) between a first laser diode array 302 and a second layer diode array 302 may be based at least in part on a diode pitch (P_{D}) of the first laser diode array 302 and/or the second layer diode array 302. In some embodiments, the diode offset distance (O_{D}) between the first laser diode array 302 and the second layer diode array 302 may be less than the diode pitch (P_{D}) of the first laser diode array 302 and/or the second layer diode array 302. For example, as shown in FIGS. 5A-5E, the diode offset distance (O_{D}) may be one-half of the diode pitch (P_{D}). Additionally, or in the alternative, the diode offset distance (O_{D}) may be one-third of the diode pitch (P_{D}), one-fourth of the diode pitch (P_{D}), one-fifth of the diode pitch (P_{D}), and so forth. For example, as shown in FIG. 6A, the diode offset distance (O_{D}) may be one-fifth of the diode pitch (P_{D}). As another example, as shown in FIG. 6B, the diode offset distance (O_{D}) may be two-fifth of the diode pitch (P_{D}). Additionally, or in the alternative, as shown in FIG. 6B, the diode offset distance (O_{D}) may differ as between longitudinally adjacent laser diode arrays 302. In some embodiments, the diode offset distance (O_{D}) between the first laser diode array 302 and the second layer diode array 302 may be from about 10% of the diode pitch (P_{D}) to about 90% of the diode pitch (P_{D}), such as from about 20% of the diode pitch (P_{D}) to about 40% of the diode pitch (P_{D}), such as from about 40% of the diode pitch (P_{D}) to about 60% of the diode pitch (P_{D}), or such as from about 60% of the diode pitch (P_{D}) to about 90% of the diode pitch (P_{D}).

In some embodiments, the diode offset distance (O_{D}) between the first laser diode array 302 and the second layer diode array 302 may be based at least in part on a diode width (wD) of the diode emitters 304 the first laser diode array 302 and/or the second layer diode array 302. For example, the diode offset distance (O_{D}) between the first laser diode array 302 and the second layer diode array 302 may be equal to or greater than, such as a multiple of, the diode width (w_{D}) of the diode emitters 304. As shown in FIGS. 5A-5E, and FIG. 6A, the diode offset distance (O_{D}) may be a multiple of 1× the diode width (w_{D}). The diode offset distance (O_{D}) may equal the diode width (w_{D}) of the diode emitters 304 of the first laser diode array 302 and/or the second layer diode array 302. Additionally, or in the alternative, the diode offset distance (O_{D}) may be at least twice the diode width, such as a multiple of 2× the diode width (w_{D}), 3× the diode width (w_{D}), 4x the diode width (w_{D}), 5× the diode width (w_{D}), and so forth. In some embodiments, the diode offset distance (O_{D}) between the first laser diode array 302 and the second layer diode array 302 may be a multiple of from about 0.1× of the diode width (w_{D}) to about 10× of the diode width (w_{D}), such as from about 1× of the diode width (w_{D}) to about 5× of the diode width (w_{D}), such as from about 1× of the diode width (w_{D}) to about 2× of the diode width (w_{D}), or such as from about 5× of the diode width (w_{D}) to about 10× of the diode width (w_{D}).

Still referring to FIGS. 5A-5E, and FIGS. 6A and 6B, in some embodiments, the diode offset distance (O_{D}) between the first laser diode array 302 and the second layer diode array 302 may provide a beam offset distance (O_{B}) between adjacent energy beams 144 of the first and second laser diode arrays 302 that is less than the diode pitch (P_{D}) of the respective laser diode arrays 302. For example, a beam offset distance (O_{B}) between a first energy beam 144 from a first diode emitter 304 of the first laser diode array 302 and a second energy beam 144 from a second diode emitter of the second laser diode array 302 may be less than the diode pitch (P_{D}) of the first and/or second laser respective laser diode arrays 302. The beam offset distance (O_{B}) may be determined relative to an optical axis (A) of respective energy beams 144. The beam offset distance (O_{B}) may include a lateral offset relative to the optical axis (A). The beam offset distance (O_{B}) may be based at least in part on a diode pitch (P_{D}) and/or a diode width (w_{D}) of the first laser diode array 302 and/or the second layer diode array 302. Additionally, or in the alternative, the beam offset distance (O_{B}) may be based at least in part on an optical power of one or more optical elements of the beam conditioning assembly 306 and/or of one or more optical elements of the beam focusing assembly 316 (FIG. 3A).

For example, as shown in FIGS. 5A-5E, the beam offset distance (O_{B}) may be one-half of the diode pitch (P_{D}). Additionally, or in the alternative, the beam offset distance (O_{B}) may be one-third of the diode pitch (P_{D}), one-fourth of the diode pitch (P_{D}), one-fifth of the diode pitch (P_{D}), and so forth. For example, as shown in FIG. 6A, the beam offset distance (O_{B}) may be one-fifth of the diode pitch (P_{D}). As another example, as shown in FIG. 6B, the beam offset distance (O_{B}) may be two-fifth of the diode pitch (P_{D}). Additionally, or in the alternative, as shown in FIG. 6B, the beam offset distance (O_{B}) may differ as between longitudinally adjacent laser diode arrays 302. In some embodiments, the beam offset distance (O_{B}) between the first laser diode array 302 and the second layer diode array 302 may be from about 10% of the diode pitch (P_{D}) to about 90% of the diode pitch (P_{D}), such as from about 20% of the diode pitch (P_{D}) to about 40% of the diode pitch (P_{D}), such as from about 40% of the diode pitch (P_{D}) to about 60% of the diode pitch (P_{D}), or such as from about 60% of the diode pitch (P_{D}) to about 90% of the diode pitch (P_{D}).

Additionally, or in the alternative, as shown in FIGS. 5A-5E, and FIG. 6A, the beam offset distance (O_{B}) between adjacent energy beams 144 may be about equal to the diode width (w_{D}). Additionally, or in the alternative, the beam offset distance (O_{B}) between a first energy beam 144 from the first laser diode array 302 and a laterally adjacent second energy beam 144 from the second layer diode array 302 may be greater than, such as a multiple of, the diode width (w_{D}) of the respective diode emitters 304 from which the energy beams 144 are emitted. For example, the beam offset distance (O_{B}) may be a multiple of 1× the diode width (w_{D}). The beam offset distance (O_{B}) may equal the diode width (w_{D}) of the diode emitters 304 of the first laser diode array 302 and/or the second layer diode array 302. Additionally, or in the alternative, the beam offset distance (O_{B}) may be a multiple of 2× the diode width (w_{D}), 3× the diode width (w_{D}), 4× the diode width (w_{D}), 5× the diode width (w_{D}), and so forth. In some embodiments, the beam offset distance (O_{B}) between adjacent energy beams 144 of the first and second laser diode arrays 302 may be a multiple of from about 1× of the diode width (w_{D}) to about 5× of the diode width (w_{D}), such as from about 1× of the diode width (w_{D}) to about 2× of the diode width (w_{D}), or such as from about 2× of the diode width (w_{D}) to about 5× of the diode width (w_{D}).

The respective energy beams 144 from the offset laser diode arrays 302 may become incident upon a build plane 130 defined by a powder bed 138. The locations on the build plane 130 irradiated by the energy beams 144 may be described with reference to a build array 502 that includes a plurality of build points 504. The respective build points 504 in the build array 502 may be identified with reference to a coordinate system, such as an (X,Y,Z) cartesian coordinate system. FIGS. 5B-5E respectively schematically depict a perspective view of the build plane 130, with the build array 502 being irradiated by an alternating pattern of energy beams provided by a plurality of laser diode arrays 302 that are offset relative to one another by a diode offset distance (O_{D}) that provides a corresponding beam offset distance (O_{B}). The build points 504 may be described with reference to a pixel width (w_{P}).

As shown in FIGS. 5B-5E, and FIGS. 6A and 6B, a plurality of energy beams 144 from respective ones of a plurality of laser diode arrays 302 that are offset relative to one another by a diode offset distance (O_{D}) may provide an alternating pattern or sequence of beam spots 322 upon the build array 502. The beam spots 322 may be mapped to the build array 502. For example, the beam spots 322 may become incident upon respective build points 504 of the build array. The energy beams 144 and/or the beam spots 322 may be offset by a beam offset distance (O_{B}). The beam offset distance (O_{B}) may correspond to a pixel width (w_{P}) of the build array 502. For example, the beam offset distance (O_{B}) may correspond to a distance between build points 504 of the build array 502. In some embodiments, the beam offset distance (O_{B}) may be about equal to the pixel width (w_{P}) of the build array 502. Additionally, or in the alternative, the beam offset distance (O_{B}) may be greater than the pixel width (w_{P}). The energy beams 144 from the plurality of laser diode arrays 302 may become incident upon an alternating pattern or sequence of build points 504 of the build array 502. Any desired pattern or sequence may be provided. For example, as shown, the sequence or pattern may alternate between an energy beam 144 from a first laser diode array 302 and an energy beam 144 from a second laser diode array 302. The first energy beam 144 from the first laser diode array 302 may become incident upon a first beam spot 322 and the second energy beam 144 from the second laser diode array 302 may become incident upon a second beam spot 322 that is adjacent to the first beam spot 322.

The beam spots 322 may propagate across the build array 502 with relative motion between the build plane 130 and the plurality of energy beams 144, such as by movement of the one or more irradiation devices 142 and/or by movement of the build plane 130. As shown in FIG. 5B, the alternating pattern or sequence of beam spots 322 may be aligned with one another, such as laterally, across the build array 502. Additionally, or in the alternative, as shown in FIGS. 5C-5E, at least some of the beam spots 322 may be longitudinally offset from one another, for example, relative to a longitudinal axis (A_{L}) of the build array 502 and/or relative to an irradiation direction 400. The longitudinal axis (A_{L}) of the build array may be parallel to the irradiation direction 400. For example, a plurality of energy beams 144 from a first laser diode array 302 may provide a first plurality of beam spots 322 that may be longitudinally offset from a second plurality of beam spots 322 corresponding to a plurality of energy beams 144 from a second laser diode array 302.

As shown in FIG. 5B, a first plurality of energy beams 144 corresponding to the first laser diode array 302 and a second plurality of energy beams 144 corresponding to the second laser diode array 302 may become incident upon a respectively corresponding plurality build points 504 that are aligned laterally with one another. The beam spots 322 corresponding to the first plurality of energy beams 144 and the second plurality of energy beams 144 may propagate across the build array 502 in a first row 506, for example, oriented parallel to a lateral or transvers axis (A_{T}) of the build array 502 and/or perpendicular to the irradiation direction 400. Additionally, or in the alternative, as shown in FIGS. 5C-5E, the first plurality of energy beams 144 corresponding to the first laser diode array 302 and the second plurality of energy beams 144 corresponding to the second laser diode array 302 may become incident upon a respectively corresponding plurality build points 504 that are longitudinally offset from one another. The first plurality of energy beams 144 may provide a first plurality of beam spots 322 incident upon a first plurality of build points 504. The second plurality of energy beams 144 may provide a second plurality of beam spots 322 incident upon a second plurality of build points 504. The first plurality of build points 504 may be longitudinally offset from the second plurality of build points 504 by a distance of one or more build points 504, such as by a distance of one or more multiples of the pixel width (w_{P}).

As shown in FIGS. 5C-5E, the beam spots 322 corresponding to the first plurality of energy beams 144 may become incident upon and propagate across the build array 502 as a first row 506, for example, oriented parallel or oblique to a lateral or transvers axis (A_{T}) of the build array 502 and/or perpendicular or oblique to the irradiation direction 400, and the beam spots 322 corresponding to the second plurality of energy beams 144 may become incident upon and propagate across the build array 502 as a second row 508, for example, oriented parallel or oblique to a lateral or transvers axis (A_{T}) of the build array 502 and/or perpendicular or oblique to the irradiation direction 400. The beam spots 322 in the first row 506 may be longitudinally offset from the beam spots 322 in the second row 508 by a distance of one or more build points 504 and/or by a distance of one or more multiples of the pixel width (w_{P}). For example, as shown in FIG. 5C, the first row 506 and the second row 508 may be longitudinally offset by one build point 504 and/or by a multiple of one pixel width (w_{P}). As shown in FIG. 5D, the first row 506 and the second row 508 may be longitudinally offset by two build points 504 and/or by a multiple of two times the pixel width (w_{P}). As shown in FIG. 5E, the first row 506 and the second row 508 may be longitudinally offset by five build points 504 and/or by a multiple of five times the pixel width (w_{P}). The first row 506 of build points 504 and the second row 508 of build points 504 may be oriented parallel or oblique to one another.

The longitudinally alignment and/or offset between the plurality of beam spots 322 corresponding to the first plurality of energy beams 144 from the first laser diode array 302 and the plurality of beam spots 322 corresponding to the second plurality of energy beams 144 from the second laser diode array 302 may be described with reference to time in an irradiation sequence, such as with reference to one or more time intervals and/or one or more instants in time during the irradiation sequence. As shown in FIG. 5B, the plurality of beam spots 322 corresponding to the first plurality of energy beams 144 and the second plurality of energy beams 144 may become incident upon the first row 506 at a first time. Additionally, or in the alternative, as shown in FIGS. 5C-5E the plurality of beam spots 322 corresponding to the first plurality of energy beams 144 may become incident upon the first row 506 at the first time, and the plurality of beam spots 322 corresponding to the second plurality of energy beams 144 may become incident upon the second row 508 at the first time. Additionally, or in the alternative, the plurality of beam spots 322 corresponding to the second plurality of energy beams 144 may become incident upon the first row 506 at the second time. The first time and the second time may depend at least in part on a rate of propagation across the build array in the irradiation direction 400.

The first time may include a time interval or an instant in time. Additionally, or in the alternative, the second time may include a time interval or an instant in time. As shown in FIG. 5B, the energy beams 144 corresponding to the first laser diode array 302 and the second laser diode array 302 may become incident upon respective build points 504 in the first row 506 at the first time, such as at the same instant in time and/or at different instances in time within a time interval of the first time. As shown in FIGS. 5C-5E, the energy beams 144 corresponding to the first laser diode array 302 may become incident upon respective build points 504 in the first row 506 at the first time and the energy beams 144 corresponding to the second laser diode array 302 may become incident upon respective build points in the second row 508 at the first time, such as at the same instant in time and/or at different instances in time within a time interval of the first time. The first time may include a first time interval of from about 1 nanosecond to about 1 second, such as from about 10 ns to about 1 microsecond, such as from about 10 microseconds to about 1 millisecond, or such as from about 10 millisecond to about 1 second. The first time and the second time may differ from one another by about 100 microsecond to about five seconds, such as from about 100 microseconds to about 1 millisecond, such as from about 100 milliseconds to about 1 second, or such as from about 1 second to about 5 seconds.

As shown in FIGS. 5A-5E, an irradiation device 142 may include one or more rows of laser diode arrays 302 and/or one or more rows of diode emitters 304. For example, as shown in FIGS. 5A-5D, two laser diode arrays 302 are shown. The first laser diode array 302 may include a first row of diode emitters 304 and/or the second laser diode array 302 may include a second row of diode emitters 304. The first laser diode array 302 and the second laser diode array 302 may be provided as part of a common irradiation device 142 and/or as part of discrete irradiation devices 142. Additionally, or in the alternative, as shown in FIG. 5E, an irradiation device 142 and/or one or more laser diode arrays 302 may include a plurality of rows of diode emitters 304. For example, as shown in FIG. 5E, an irradiation device 142 and/or a diode array 302 may include three rows of diode emitters 304. Additionally, or in the alternative, the rows of diode emitters 304 shown in FIGS. 5A-5D may be provided as a two-dimensional laser diode array 302.

As shown in FIG. 5E, a laser diode array 302 that includes a two-dimensional array of diode emitters 304 and/or a plurality of rows of diode emitters 304. As shown in FIG. 5E, the diode array 302 may include a plurality of diode emitters 304 that are arranged in columns a plurality of columns. Respective ones of a plurality of columns of diode emitters 304 may be longitudinally aligned with one another, for example, relative to a longitudinal axis (A_{L}) of the build array 502. Additionally, or in the alternative, a plurality of energy beams 144 respectively emitted by respective ones of the plurality of diode emitters 304 may provide a corresponding plurality of columns of beam spots 322 upon the build array 502. Respective ones of the plurality of columns of beam spots 322 may be longitudinally aligned with one another, such as relative to a longitudinal axis (A_{L}) of the build array 502. A respective plurality of beam spots 322 that are aligned in a column may be longitudinally aligned with one another along a longitudinal axis (A_{L}) of the build array 502 and/or parallel to an irradiation direction 400. Additionally, or in the alternative, the laser diode array 302 may include at least some diode emitters 304 that provide corresponding beam spots 322 that are longitudinally offset from one another, for example, relative to a longitudinal axis (A_{L}) of the build array 502, such as shown in FIGS. 5C and 5D.

As shown in FIG. 5E, a first irradiation device 142 and/or a first laser diode array 302 may include a first column of diode emitters 304 that emit a first plurality of energy beams 144, and the first plurality of energy beams 144 may provide a first plurality of beam spots 322 arranged in a first column parallel to a longitudinal axis of the (A_{L}) of the build array 502. A second irradiation device 142 and/or a second laser diode array 302 may include a second column of diode emitters 304 that emit a second plurality of energy beams 144, and the second plurality of energy beams 144 may provide a second plurality of beam spots 322 arranged in a second column parallel to the longitudinal axis of the (A_{L}) of the build array 502. The first column of beam spots 322 and the second column of beam spots 322 may be laterally offset from one another, for example, relative to a longitudinal axis (A_{L}) of the build array 502 and/or relative to an irradiation direction 400. The first and second column of beam spots 322 may propagate across the build array 502, for example, oriented parallel to the longitudinal axis of the (A_{L}) of the build array 502 and/or parallel to the irradiation direction 400. The beam spots 322 in the first column may be laterally offset from the beam spots 322 in the second column by a distance of one or more build points 504 and/or by a distance of one or more multiples of the pixel width (w_{P}). For example, as shown in FIG. 5E, the beam spots 322 in the first column may be laterally offset from the beam spots 322 in the second column by one build point 504 and/or by a multiple of one pixel width (w_{P}). Additionally, or in the alternative, the beam spots 322 in the first column may be laterally offset from the beam spots 322 in the second column by a plurality of build points, such as two build points 504, and/or by a multiple of the pixel width (w_{P}), such as two times the pixel width (w_{P}). As shown in FIG. 5E, the first row 506 and the second row 508 may be laterally offset by five build points 504 and/or by a multiple of five times the pixel width (w_{P}). The first row 506 of build points 504 and the second row 508 of build points 504 may be oriented parallel to one another.

The configurations and arrangements of the laser diode arrays 302 described with reference to FIGS. 5A-5E may allow for an irradiation device 142 to scan a build array 502 that has a pixel width (w_{P}) of build points 504 that is smaller than the diode pitch (P_{D}) of the diode emitters 304 of the laser diode arrays 302. In some embodiments, the pixel width (w_{P}) of the build array 502 may be from about 1 micrometer (μm) to about 500 μm, such as from about 25 μm to about 250 μm, such as from about 10 μm to about 100 μm, such as from about 25 μm to about 50 μm, such as from about 50 μm to about 100 μm, or such as from about 100 μm to about 150 μm. Additionally, or in the alternative, a beam spot 322 and/or respective ones of the plurality of beam spots 322 may have a width of from about 1 micrometer (m) to about 500 μm, such as from about 25 μm to about 250 μm, such as from about 10 μm to about 100 μm, such as from about 25 μm to about 50 μm, such as from about 50 μm to about 100 μm, or such as from about 100 μm to about 150 μm.

In some embodiments, the build points 504 of the build array 502 may have a pixel width (w_{P}) that correspond to the width of the beam spots 322 from the energy beams 144 emitted by the diode emitters 304 of the diode arrays 302. For example, the pixel width (w_{P}) and the width of the beam spots 322 may respectively be from about 1 micrometer (μm) to about 500 μm, such as from about 25 μm to about 250 μm, such as from about 10 μm to about 100 μm, such as from about 25 μm to about 50 μm, such as from about 50 μm to about 100 μm, or such as from about 100 μm to about 150 μm. In some embodiments, the pixel width (w_{P}) and the beam spots 322 may differ from one another by about 1 μm to about 250 μm, such as from about 10 μm to about 100 μm , such as from about 1μm to about 50 μm, such as from about 10 μm to about 25 μm, such as by less than about 100 μm, such as by less than about 50 μm, such as by less than about 25 μm, such as by less than about 10 μm, or such as by less than about 5 μm.

In some embodiments, the pixel width (w_{P}) and/or the beam spots 322 may be about 50% of the diode pitch (P_{D}), such as from about 30% to about 70% of the diode pitch (P_{D}), or such as from about 40% to about 60% of the diode pitch (P_{D}).

In some embodiments, the beam offset distance (O_{B}) between adjacent energy beams 144 of the first and second laser diode arrays 302 may be a multiple of from about 1× of the diode width (w_{D}) to about 5× of the diode width (w_{D}), such as from about 1× of the diode width (w_{D}) to about 2× of the diode width (w_{D}), or such as from about 2× of the diode width (w_{D}) to about 5× of the diode width (w_{D}).

In some embodiments, the laser diode arrays 302 may provide an energy density per beam spot 322 of from about 0.1 W/cm² to about 500 W/cm², such as from about 1 W/cm² to about 100 W/cm², such as from about 50 W/cm² to about 250 W/cm², such as from about 250 W/cm² to about 500 W/cm². In some embodiments, the diode emitters 304 may be configured to pulse at a desired pulse frequency. The pulse frequency may be constant or variable. In some embodiments, the pulse frequency may be from about 10 MHz to about 100 GHz, such as from about 10 MHz to about 100 MHz, such as from about 100 MHz to about 250 MHz, such as from about 250 MHz to about 500 MHz, such as from about 500 MHz to about 1 GHz, such as from about 1 GHz to about 50 GHz, or such as from about 50 GHz to about 100 GHz. In some embodiments, the pulse frequency may be varied to provide a desired energy density to the powder bed 138.

The beam spots may have any desired cross-sectional profile, such as round, oval, square, rectangular, or any other suitable cross-sectional profile. The energy beams 144 may exhibit any desired intensity profile, such as a Gaussian profile, a top-hat profile, or any other suitable intensity profile.

The energy beams 144 may have a wavelength in the ultraviolet spectrum (about 1 nanometer (nm) to about 400 nm), the visible spectrum (about 400 nm to about 750 nm), and/or the near-infrared spectrum (about 750 nm to about 2,500 nm). For example, the energy beams 144 may have a wavelength of from about 300 nm to about 2000 nm, such as from 400 nm to about 1,100 nm, or such as from about 1,000 nm to about 1,100 nm.

Referring now to FIGS. 6A and 6B, in some embodiments, an irradiation device 142 may include one or more laser diode arrays 302 coupled to an irradiation carriage 600. The irradiation carriage 600 may include one or more laser diode arrays 302 that individually or collectively provide a plurality of rows of diode emitters 304 that are laterally offset relative to one another, as described, for example, in FIGS. 5A-5E. The irradiation carriage may include one or more lateral elements 602 and/or one or more longitudinal elements 604. The laser diode arrays 302 may be coupled to the irradiation carriage 600 in any suitable manner. For example, as shown in FIGS. 6A and 6B, respective ones of a plurality of laser diode arrays may be coupled to a corresponding lateral elements 602. The lateral elements 602 may be coupled to one or more longitudinal element 604, such as to left and right longitudinal elements 604.

As shown in FIGS. 6A and 6B, the one or more laser diode arrays 302 may respectively include one or more rows of diode emitters 304. For example, as shown in FIGS. 6A and 6B, an irradiation device 142 may include a plurality of laser diode arrays 302, and respective ones of the plurality of laser diode arrays 302 may include at least one row of diode emitters 304. Additionally, or in the alternative, an irradiation device 142 may include at least one laser diode arrays 302 that has a plurality of rows of diode emitters 304, as shown, for example, in FIG. 3C. Regardless of the number of laser diode arrays 302, the plurality of rows of diode emitters 304 may be laterally offset relative to one another. For example, while FIG. 3C shows a laser diode array 304 that includes a plurality of rows of diode emitters 304 that appear to be laterally aligned with one another, in some embodiments the laser diode array 302 shown in FIG. 3C may include a plurality of rows of diode emitters 304 that are laterally offset relative to one another.

In some embodiments, the number of rows of diode emitters 304 may be proportional to a ratio of the diode width (w_{D}) to the diode pitch (P_{D}). The respective rows of diode emitters 304 may be laterally offset by a diode offset distance (O_{D}) that corresponds or equates to the diode width (w_{D}). The diode offset distance (O_{D}) may be equal to the diode width (w_{D}), or the diode offset distance (O_{D}) may be less than the diode width (w_{D}) or greater than, such as a multiple of, of the diode width (w_{D}). For example, the number of rows of diode emitters 304 may be described with reference to the following relationship: N=(P_{D}/w_{D})/k_{D}, where k_{D} is a diode overlap factor and N is the number of rows of diode emitters 304. The diode overlap factor (kD) describes a lateral overlap with respect to diode emitters 304 that provide laterally adjacent beam spots 322. A diode overlap factor of 1.0 represents diode emitters 304 that are laterally offset by a diode width (w_{D}). As shown in FIGS. 6A and 6B, k_{D}=1.0 and (P_{D}/W_{D})=5. A diode overlap factor (k_{D}) of less than 1.0 represents diode emitters 304 that are laterally offset by a distance that is less than the diode width (w_{D}). For example, for the configuration shown in FIGS. 6A and 6B, a diode overlap factor (k_{D}) of 0.5 would equate to ten (10) rows of diode emitters 304 respectively overlapping by 50%. A diode overlap factor of greater than 1.0 represents diode emitters 304 that are laterally offset by a distance that is greater than the diode width (w_{D}). The diode overlap factor may be from about 0.1 to about 2.0, such as from about 0.1 to about 0.5, such as from about 0.5 to about 1.0, such as from about 1.0 to about 1.5, or such as from about 1.5 to about 2.0. For example, for the configuration shown in FIGS. 6A and 6B, a diode overlap factor (k_{D}) of 1.67 would equate to three (3) rows of diode emitters 304 respectively overlapping by 167% of the diode width (w_{D}). As shown in FIGS. 6A and 6B, five rows of diode emitters 304 are provided.

The diode offset distance (O_{D}) may provide a corresponding beam offset distance (O_{B}). The beam offset distance (O_{B}) may correspond or equate to the diode offset distance (O_{D}). The beam offset distance (O_{B}) may be equal to the diode offset distance (O_{D}), or the beam offset distance (O_{B}) may be a less than the diode offset distance (O_{D}) or a multiple of the diode offset distance (O_{D}). For example, the beam offset distance (O_{B}) may be described with reference to the following relationship: O_{B}=O_{D}√k_{B}, where k_{B} is a focus factor of the respective energy beams. The focus factor represents the extent to which the lateral position of respectively adjacent beam spots 322 are augmented by a beam focusing assembly 316 and/or one or more focusing lenses 320 thereof augmenting a lateral position of corresponding energy beams 144, for example, causing the respective beam spots 322 to become closer together or further apart. The focus factor may be from about 0.1 to about 1.0, such as from about 0.3 to about 0.7, or such as from about 0.7 to about 1.0.

The diode offset distance (O_{D}) and/or the beam offset distance (O_{B}) may be configured to orient a plurality of energy beams 144 corresponding to the respective diode emitters 304 to provide beam spots 322 that become incident upon build points 504 of a build array 502. The beam offset distance (O_{B}) may provide a corresponding pixel width (w_{P}) determined between beam spots 322 and/or build points 504 of the build array 502. The pixel width (w_{P}) may correspond or equate to the beam offset distance (O_{B}). Additionally, or in the alternative, the pixel width (w_{P}) may correspond or equate to the diode width (w_{D}). The pixel width (w_{P}) may be equal to the beam offset distance (O_{B}) and/or the diode width (w_{D}), or the pixel width (w_{P}) may be a less than the beam offset distance (O_{B}) and/or diode width (w_{D}), or the pixel width (w_{P}) may be a multiple of the beam offset distance (O_{B}) and/or diode width (w_{D}).

In some embodiments, the pixel width (w_{P}) may be less than the diode pitch diode pitch (P_{D}). Additionally, or in the alternative, the pixel width (w_{P}) may be proportional to a ratio of the diode pitch (P_{D}) to the number of rows of diode emitters 304. For example, the pixel width (w_{P}) may be described with reference to the following relationship: w_{P}=(P_{D}/N)/k_{P}, where k_{P} is a pixel overlap factor (k_{P}), and N is the number of rows of diode emitters 304. The pixel overlap factor may be from about 0.1 to about 2.0, such as from about 0.1 to about 0.5, such as from about 0.5 to about 1.0, such as from about 1.0 to about 1.5, or such as from about 1.5 to about 2.0. As shown in FIGS. 6A and 6B, k_{P}=1.0 and w_{P}=(P_{D}/N),=0.2.

As shown in FIG. 6A, adjacent rows of diode emitters 304 may be laterally offset incrementally across a diode pitch (P_{D}). Additionally, or in the alternative, as shown in FIG. 6B, the rows of diode emitters 304 may be laterally offset in an alternating or asynchronous pattern across a diode pitch (P_{D}). For example, the alternating or asynchronous pattern may provide adjacent rows of diode emitters 304 that are laterally offset by at least a multiple of 2× the diode width (w_{D}). In this way, a longitudinal offset and/or delay between adjacent beam spots 322 becoming incident upon a respective row of the build array 502 may be provided. A lateral offset of at least a multiple of 2× the diode width (w_{D}) may provide rows of longitudinally offset beam spots 322 that form sequential hatch lines across the powder bed 138 with a suitable space between them, with the spaces filled-in by hatch lines formed from beam spots 322 from subsequent rows of diode emitters that are separated by at least one intermediate row of diode emitters 304.

The lateral offset may be configured such that spaces between adjacent one of the first plurality of hatch lines are filled in by hatch lines formed by a row of beam spots 322 from a row of diode emitters 304 preceded by at least one intermediate row of diode emitters 304. Respective rows of diode emitter 304 that provide abutting and/or partially overlapping hatch lines may be separated by at least one row of diode emitters 304. For example, a first and third row of diode emitters 304 may provide beam spots 322 that form abutting and/or partially overlapping hatch lines, and the first and third row of diode emitters 304 may be separated by at least a second row of diode emitters 304. In some embodiments, the beam offset distance (O_{B}) may provide suitable spacing to allow for some cooling and/or melt pool contraction prior to a sequential beam spots 322 abutting and/or partially overlapping a hatch line, whether in a solidified or partially molten condition.

By way of illustration, as shown in FIG. 6B, a first row of diode emitters 304 may emit a first plurality of energy beams 144 that provide a first plurality of beam spots 322. The first plurality of beam spots 322 may be spaced apart by a beam pitch (P_{B}). A first plurality of hatch lines formed by the first plurality of beam spots 322 may be spaced apart by a beam pitch (P_{B}). A second row of diode emitters 304 may emit a second plurality of energy beams 144 that provide a second plurality of beam spots 322. The second plurality of beam spots 322 may be spaced apart by the beam pitch (P_{B}). A second plurality of hatch lines formed by the second plurality of beam spots 322 may be spaced apart by a beam pitch (P_{B}). The second plurality of beam spots 322 may occupy a space between adjacent ones of the first plurality of hatch lines formed by the first plurality of beam spots 322, for example, with a space between the second plurality of beam spots 322 and the first plurality of hatch lines formed by the first plurality of beam spots 322. The second plurality of hatch lines formed by the second plurality of beam spots 322 may occupy a space between adjacent ones of the first plurality of hatch lines formed by the first plurality of beam spots 322, for example, with a space between the second plurality of hatch lines formed by the first plurality of beam spots and the first plurality of hatch lines formed by the first plurality of beam spots 322.

A third or subsequent row of diode emitters 304 may emit a third or subsequent plurality of energy beams 144 that provide a third or subsequent plurality of beam spots 322. The third or subsequent plurality of beam spots 322 may be spaced apart by the beam pitch (P_{B}). A third or subsequent plurality of hatch lines formed by the third or subsequent plurality of beam spots 322 may be spaced apart by a beam pitch (P_{B}). The third or subsequent plurality of beam spots 322 may occupy a space between respective ones of a first hatch line formed by a first beam spot 322 and a second hatch line formed by a second beam spot 322. A third beam spot 322 propagating across the build array 502 subsequent to a second beam spot 322 may be abutting and/or partially overlapping a first hatch line formed by a first beam spot 322. A fourth beam spot 322 propagating across the build array subsequent to a third beam spot may be abutting and/or partially overlapping a second hatch line formed by a second beam spot 322. A width of the build array 502 corresponding to the beam pitch (P_{B}) may be sequentially irradiated by respective beam spots 322 corresponding to sequential rows of laser diode arrays, with each sequential beam spot 322 being laterally offset by at least a multiple of 2× the diode width (w_{D}).

In some embodiments, as shown in FIGS. 6A and 6B, an irradiation device may include a plurality of laser diode arrays 302 that have adjustable positioning relative to one another, such as by one or more actuators 606, or the like. The one or more actuators may allow for positional adjustment of the respective laser diode arrays 302 in one or more directions. For example, an actuator 606 may be configured to provide a lateral positional adjustment 608. The lateral positional adjustment 608 may be utilized at least in part to laterally position the respective laser diode array 302, including, for example, providing a diode offset distance (O_{D}) and/or providing fine-tuning of the lateral position and/or of the diode offset of the respective laser diode array 302. Additionally, or on the alternative, an actuator 606 may be configured to provide a longitudinal positional adjustment 610. The longitudinal positional adjustment 610 may be utilized at least in part to longitudinally position the respective laser diode array 302, including, for example, providing a longitudinal offset and/or providing fine-tuning of the longitudinal position and/or of the longitudinal offset of the respective laser diode array 302. Additionally, or on the alternative, an actuator 606 may be configured to provide a vertical positional adjustment 612. The vertical positional adjustment 612 may be utilized at least in part to vertically position the respective laser diode array 302, including, for example, providing a vertical offset and/or providing fine-tuning of the vertical position and/or of the vertical offset of the respective laser diode array 302. The vertical position adjustment may include tip and/or tilt adjustments. Additionally, or in the alternative, an actuator 606 may be configured to position a respective laser diode array 302 with respect to pitch, yaw, or roll, including, for example, fine-tuning the position of the respective laser diode array 302 with respect to pitch, yaw, and/or roll. The one or more actuators 606 may be actuated by any desired motive force, including electric, hydraulic, pneumatic, and/or mechanical motive force. Additionally, or in the alternative, the one or more actuators 606 may be actuated manually, such as by an operator or a technician that applies a mechanical motive force, such as using a tool.

As shown in FIGS. 6C and 6D, in some embodiments, an irradiation carriage 600 may include one or more actuators 606 that include one or more piezoelectric elements 614. It will be appreciated that the actuator 606 described with reference to FIGS. 6C and 6D is provided by way of example and not to be limiting. In fact, an actuator may include any suitable configuration or arrangement, and/or an actuator may utilize any suitable motive force. As shown, an actuator 606 may include one or more piezoelectric elements 614 configured to move a laser diode array 302 relative to the irradiation carriage 600 and/or relative to one or more lateral elements 602 and/or one or more longitudinal elements 604 thereof. By way of example, the one or more piezoelectric elements 614 may be configured to exert a piezoelectric motive force, and one or more gripping elements 616 configured to move an actuating element 618 responsive to the motive force from the piezoelectric elements 614. The actuating element 618 may be a fine-thread screw. The one or more gripping elements 616 may be configured to rotate the actuating element 618, such as a fine-thread screw. The one or more piezoelectric elements 614 may provide a step length that corresponds to a rotation of the actuating element 618 of from about 0.1 microradians (gad) to about 100 μrad, such as from about 0.1 μrad to about 10 μrad, or such as from about 0.1 μrad to about 1 μrad. The rotation of the actuating element 618 may provide a linear displacement of the actuating element 618 of from about 1 nanometer (nm) per step to about 1,000 nm per step, such as from about 10 nm per step to about 500 nm per step. The one or more gripping elements 616 may include teeth 620 that mate with or otherwise grip a surface of the actuating element 618. The actuator 606 may include a preload element 622, such as a spring or the like, configured to apply a force that holds the one or more gripping elements 616 in contact with the actuating element 618. In some embodiments, the actuator 606 may be configured as an inertia drive. Additionally, or in the alternative, the actuator 606 may be self-locking when at rest. The actuator 606 may provide a holding force of from about 10 newtons (N) to about 150 N, such as from about 25 N to about 100 N.

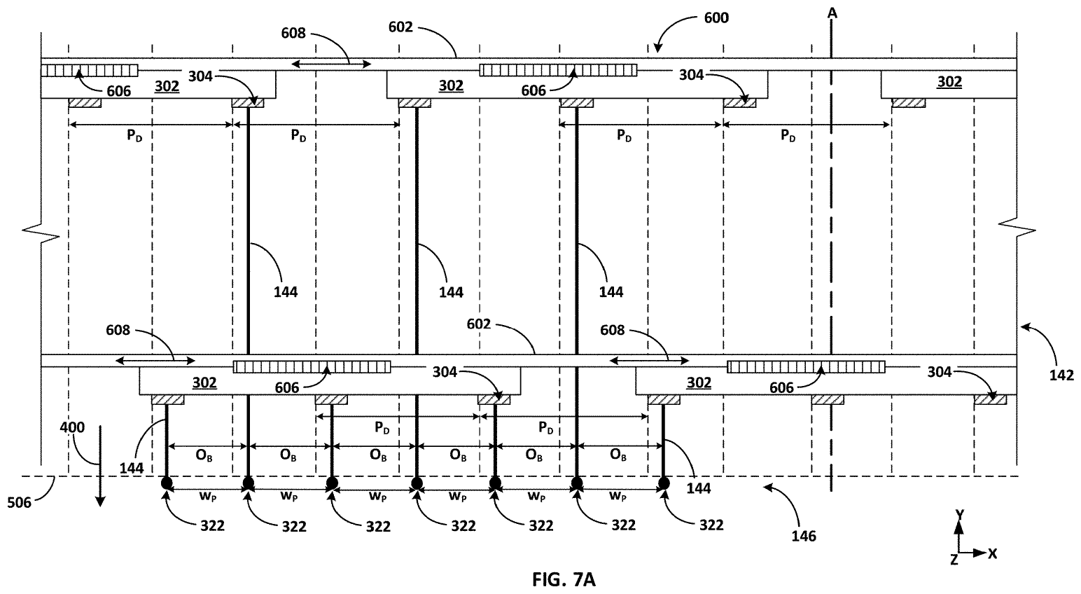

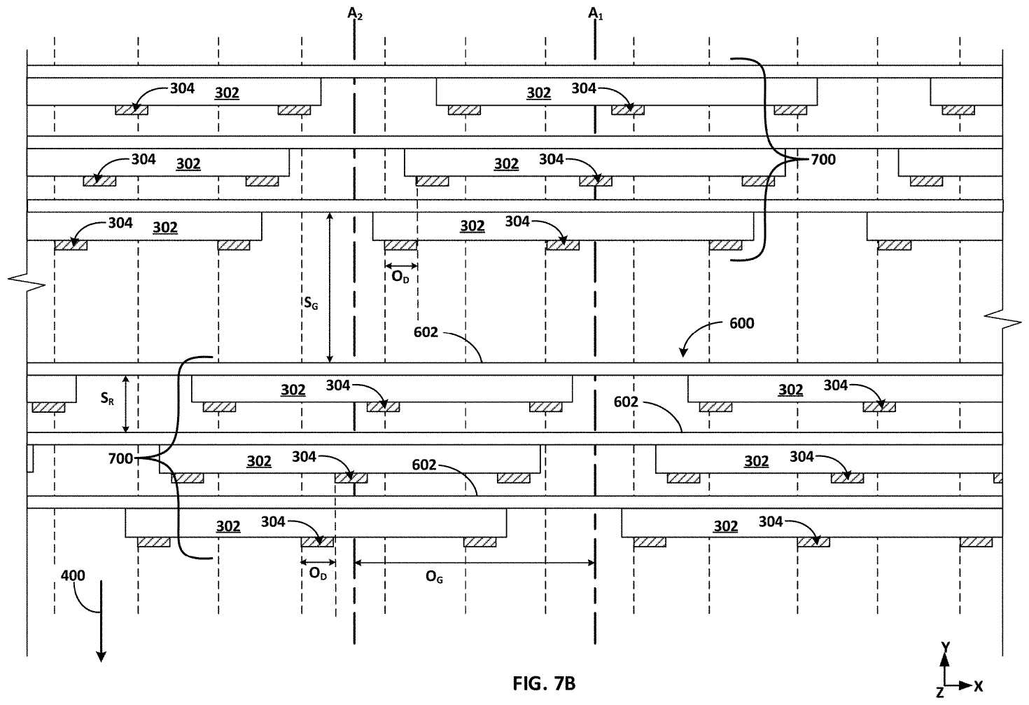

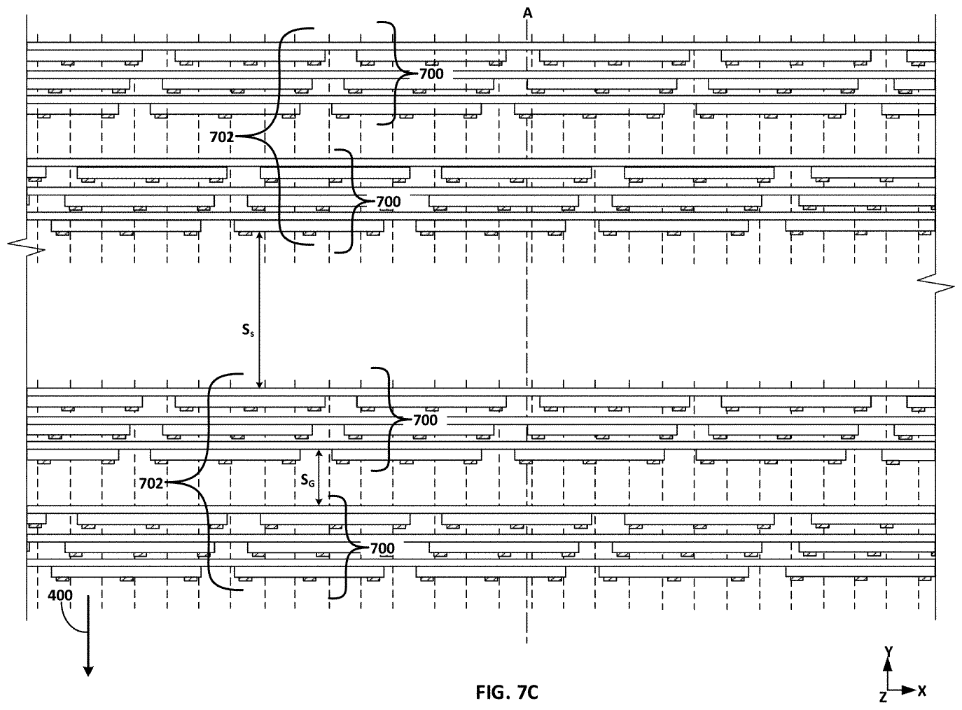

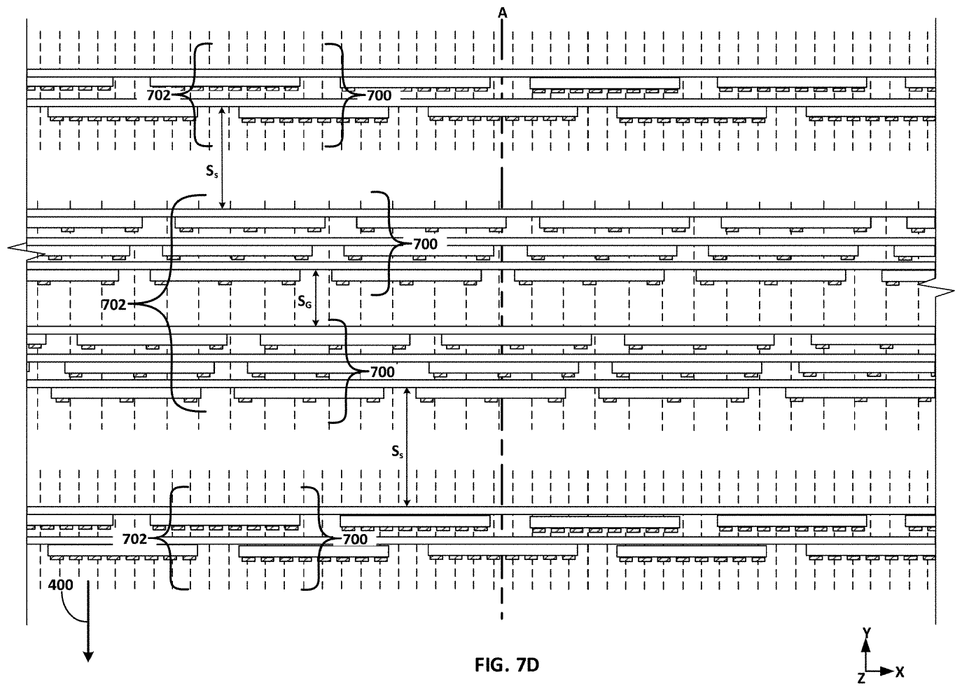

Referring now to FIGS. 7A-7D, exemplary configurations and arrangements of laser diode arrays 302 are further described. In some embodiments, as shown, for example, in FIG. 7A, an irradiation device 142 may include a plurality of laser diode arrays 302 that are arranged laterally adjacent to one another. A plurality of laterally adjacent laser diode arrays 302 may be coupled to an irradiation carriage 600, such as to one or more lateral elements 602 and/or one or more longitudinal elements 604 thereof. The respective laterally adjacent laser diode arrays 302 may be spaced apart from one another laterally by a distance that corresponds or equates to a factor of the diode pitch (P_{D}). A plurality of rows of laser diode arrays 302 may be laterally offset relative to one another to provide one or more extended rows of diode emitters 304 with a desired diode pitch (P_{D}), beam offset distance (O_{B}), and/or pixel width (w_{P}) across the plurality of laterally adjacent laser diode arrays

As shown in FIG. 7A, a diode pitch (P_{D}) between adjacent diode emitters 304 of a respective laser diode array 302 may correspond or equate to a diode pitch (P_{D}) as between adjacent diode emitters 304 of respectively adjacent laser diode arrays 302. For example, a diode pitch (P_{D}) between a laterally adjacent pair of diode emitter 304 of a first laser diode array 302 may correspond or equate to a diode pitch (P_{D}) between a first diode emitter 304 of the first laser diode array 302 and a second diode emitter 304 of a second laser diode array 302. In this way, an effective length of a row of laterally adjacent diode emitters 304 may be extended by adding one or more sequential rows of laterally adjacent laser diode arrays 302, for example, while maintaining an effective diode pitch (P_{D}) pitch across the plurality of laterally adjacent laser diode arrays 302. The one or more sequential rows of laterally adjacent laser diode arrays 302 may be provided at least in part to locate energy beams 144 with respect to a space between laterally adjacent laser diode arrays 302 of one or more preceding rows.

In some embodiments, an exemplary laser diode array 302 may have a width of from about 10 millimeters (mm) to about 100 mm, such as from about 10 mm to about 50 mm, such as from about 10 mm to about 25 mm, or such as from about 25 mm to about 75 mm. An exemplary irradiation device 142 may include any suitable number of laser diode arrays respectively configured and arranged laterally adjacent to one another. For example, an irradiation device 142 may include from 2 to 10 laterally adjacent laser diode arrays 302, such as from 2 to 5, or such as from 5 to 10 laterally adjacent laser diode arrays 302. The number of laterally adjacent laser diode arrays 302 may be determined based at least in part on a desired scan field width. The laterally adjacent laser diode arrays 302 may provide a scan field that has a width of from about 50 mm to about 1,000 mm, such as from about 50 mm to about 100 mm, such as from about 100 mm to about 250 mm, such as from about 250 mm to about 500 mm, or such as from about 500 mm to about 1,000 mm.

As shown in FIGS. 7B-7D, in some embodiments, an irradiation device 142 may include a plurality of diode array groups 700. The plurality of diode array groups 700 may respectively include a plurality of laser diode arrays 302. In some embodiments, respective diode array groups 700 may be differentiated at least in part by spatial separation. For example, longitudinally adjacent diode array groups 700 may be separated from one another by a group separation distance (S_{G}). Additionally, or in the alternative, longitudinally adjacent rows of laser diode arrays 302 may be separated from one another by a row separation distance (R_{G}). A group separation distance (S_{G}) may be larger than a row separation distance (R_{G}). The laser diode arrays 302 within a diode array group 700 may be laterally offset from one another as described herein. Additionally, or in the alternative, the respective diode array groups 700 may be laterally offset from one another. For example, the diode array groups 700 may be laterally offset by a group offset distance (O_{G}). The laser diode arrays 302 within a diode array group 700 may be laterally offset by a diode offset distance (O_{D}). The group offset distance (O_{G}) may be larger than the diode offset distance (O_{D}). In some embodiments, the group offset distance (O_{G}) may be selected at least in part to sustain a desired diode pitch (P_{D}), beam offset distance (O_{B}), and/or pixel width (w_{P}) with respect to a space between laterally adjacent laser diode arrays 302.

As shown in FIGS. 7C and 7D, in some embodiments, an irradiation device 142 may include a plurality of diode array sets 702. A diode array set 702 may include one or more diode array groups 700, such as a plurality of diode array groups 700. The plurality of diode array groups 700 may respectively include a plurality of laser diode arrays 302. In some embodiments, respective diode array sets 702 may be differentiated at least in part by spatial separation. For example, longitudinally adjacent diode array sets 702 may be separated from one another by a set separation distance (S_{S}). Additionally, or in the alternative, longitudinally adjacent diode array groups 700 may be separated from one another by a group separation distance (S_{G}). A set separation distance (S_{S}) may be larger than a group separation distance (S_{G}). In addition, or in the alternative, to spatial separation, respective diode array sets 702 may be differentiated at least in part by one or more properties of the laser diode arrays 302, and/or at least in part by one or more irradiation parameters, such as beam power, beam intensity, intensity profile, wavelength, spot size, and/or spot shape. Additionally, or in the alternative, respective diode array sets 702 may be differentiated at least in part by a quantity of heat imparted to the powder bed 138. For example, respective diode array sets 702 may be configured to impart heat to the powder bed 138 for respectively different purposes. For example, a diode array set 702 may be configured to provide pre-heating, lasing, re-melting, and/or post-treating. Pre-heating may include imparting heat to the powder bed 138 without generating a melt-pool. Lasing may include imparting heat to the powder bed 138 sufficient to generate a melt-pool. Re-melting may include imparting heat to previously-melted portions of the powder bed 138 sufficient to re-melt such previously-melted portions. Post-treating may include imparting heat to the powder bed 138, including previously melted and/or un-melted portions of the powder bed 138, without generating a melt-pool.

In some embodiments, as shown, for example, in FIG. 7B, a first diode array set 702 may be configured to provide lasing, and a second diode array set 702 may be configured to provide one of pre-heating, re-melting, and/or post-treating. Additionally, or in the alternative, as shown, for example, in FIG. 7C, a first diode array set 702 may be configured to provide pre-heating, a second diode array set 702 may be configured to provide lasing, and a third diode array set 702 may be configured to provide post-treating.

In some embodiments, as shown, for example, in FIG. 7D, a diode array set 702 configured to provide pre-heating may include a plurality of laser diode arrays 302 that have different properties as compared to one or more laser diode arrays 302 included in a diode array set 702 configured to provide lasing. Additionally, or in the alternative, a diode array set 702 configured to provide post-treating may include a plurality of laser diode arrays 302 that have different properties as compared to one or more laser diode arrays 302 included in a diode array set 702 configured to provide lasing. For example, the respective laser diode arrays 302 may differ in respect of diode pitch (P_{D}) and/or diode width (w_{D}). In some embodiments, laser diode arrays 302 configured to provide pre-heating and/or post-treating may have a smaller diode pitch than laser diode arrays 302 configured to provide lasing. Additionally, or in the alternative, laser diode arrays 302 configured to provide pre-heating and/or post-treating may have a larger diode width (w_{D}) than laser diode arrays 302 configured to provide lasing. Additionally, or in the alternative, laser diode arrays 302 configured to provide pre-heating and/or post-treating may differ from laser diode arrays 302 configured to provide lasing in respect of beam offset distance (O_{B}) and/or pixel width (w_{P}). For example, laser diode arrays 302 configured to provide pre-heating and/or post-treating may have a smaller beam offset distance (O_{B}) and/or pixel width (w_{P}) relative to laser diode arrays 302 configured to provide lasing. Additionally, or in the alternative, the number of rows of diode emitters 304 and/or the number of rows of laser diode arrays 302 in a diode array group 700 may differ as between a diode array set 702 configured to provide lasing and a diode array set 702 configured to provide pre-heating and/or post-treating. For example, for a given beam offset distance (O_{B}) and/or pixel width (w_{P}), a diode array set 702 configured to provide lasing may include a larger number of rows of diode emitters 304 and/or laser diode arrays 302 as compared to a diode array set 702 configured to provide pre-heating and/or post-treating.

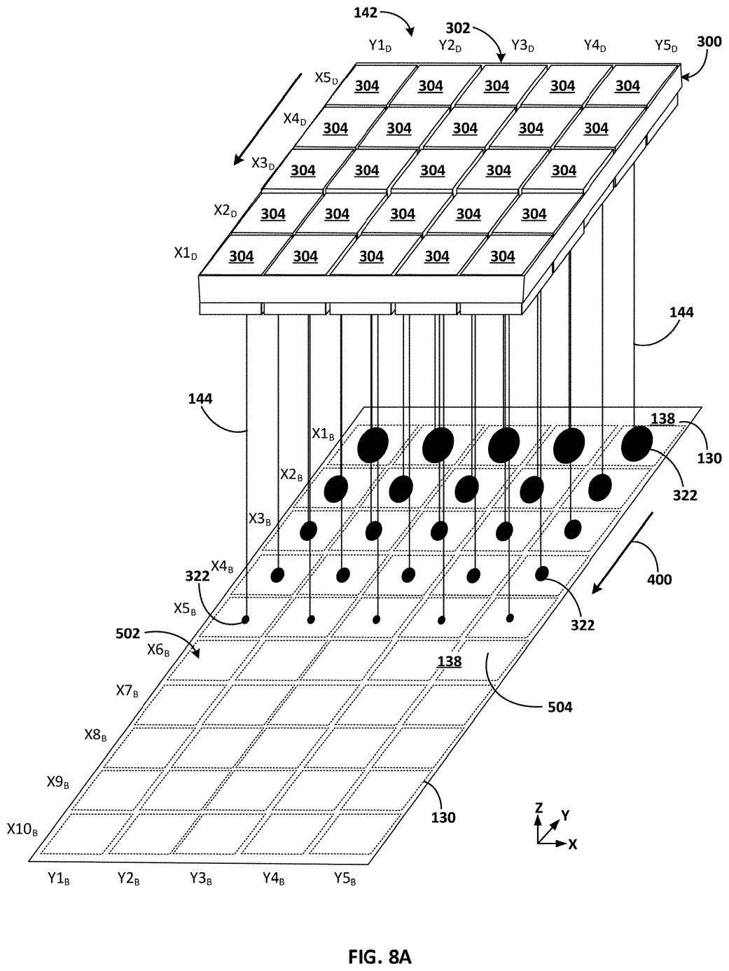

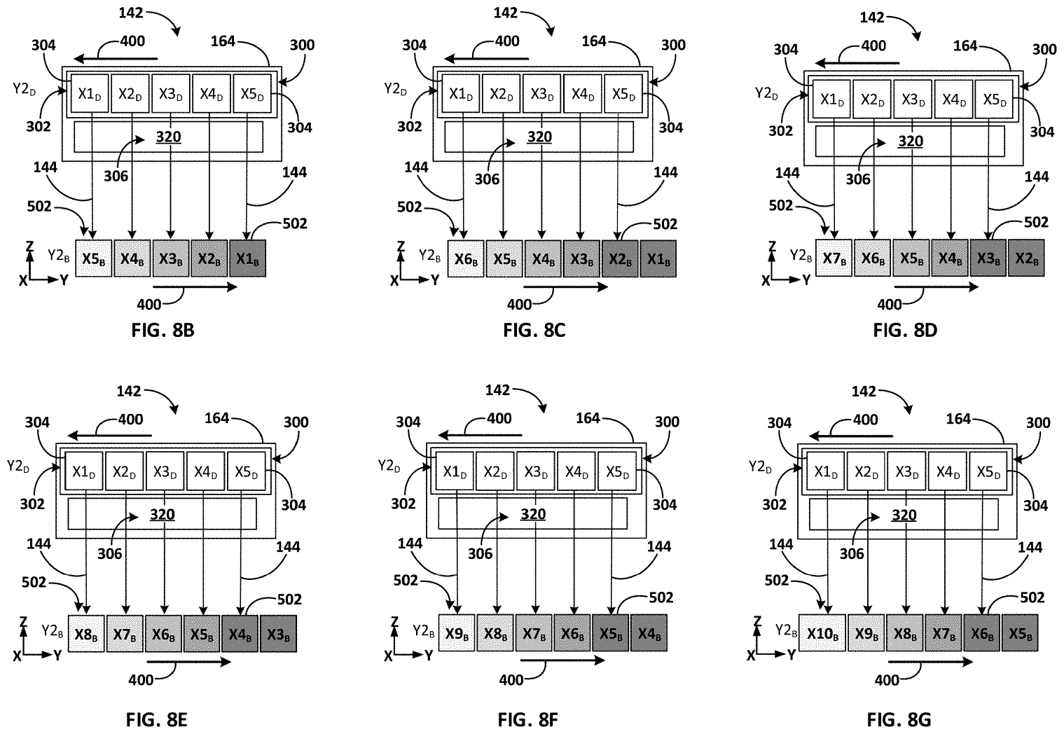

Referring now to FIGS. 8A-8G, an exemplary irradiation sequence will be described. FIGS. 8A-8G show a build plane 130 that includes a powder bed 138 that may be described with reference to a build array 502 that includes a plurality of build points 504. The respective build points 504 in the build array 502 may be identified with reference to a coordinate system, such as an (X,Y,Z) cartesian coordinate system. FIG. 8A schematically depicts a perspective view of the build plane 130, with the build array 502 being irradiated by an irradiation device 142 according to an exemplary irradiation sequence. By way of example, the build array 502 includes build points 504 located from (X1_{B},Y1_{B}) to (X10_{B},Y5_{B}). FIGS. 8B-8G schematically depict a side view of the irradiation sequence depicted in FIG. 8A, with respect to column Y2 B of the build array 502.

As shown in FIG. 8A, an irradiation device 142 may include one or more laser diode arrays 302 that collectively provides a plurality of rows of diode emitters 304 respectively configured to provide a beam spot 322 upon the powder bed 138. The powder bed 138 may define a build plane 130. Spatial locations of the build plane 130 may be described with reference to a build array 502 that includes a plurality of build points 504. The plurality of diode emitters 304 and the build array 502 may be related to one another by a mapping relationship. The mapping relationship may include respective diode emitters 304 associated with or coordinated to respective build points 504 in the build array 502. As shown, a beam generation device 300 may include one or more laser diode arrays 302 that includes a plurality of diode emitters 304. By way of example, five (5) rows of diode emitters 304 are provided. A first row of diode emitters may have coordinates (X1_{D},Y1_{D}) through (X1_{D},Y5_{D}). Collectively, the plurality of diode emitters 304 may have coordinates (X1_{D},Y1_{D}) through (X5_{D},Y5_{D}). The plurality of diode emitters 304 may be provided by a plurality of laterally offset laser diode arrays 302 as described herein. Such lateral offset is not depicted in FIGS. 8A-8F in order to aid the reader and to direct the reader's attention to the particulars of the exemplary irradiation sequence. It will be appreciated that the exemplary irradiation sequence may be implemented using any suitable configuration and arrangement of laser diode arrays 302, including, for example, the configurations and arrangements disclosed herein. The plurality of diode emitters 304 may be mapped to a build array 502 that, by way of example, may include build points 504 with coordinates (X1_{B},Y1_{B}) through (X10_{B},Y5_{B}).

As shown in FIG. 8A, the plurality of diode emitters 304 with coordinates (X1_{D},Y1_{D}) through (X5_{D},Y5_{D}) may be mapped or coordinated to the build points 504 with coordinates (X1_{B},Y1_{B}) through (X5_{B},Y5_{B}). For example, a diode emitter 304 located at (X1_{D},Y1_{D}) may provide an energy beam 144 that becomes incident upon a build point located at (X5_{B},Y1_{B}). Additionally, or in the alternative, a diode emitter 304 located at (X5_{D},Y5_{D}) may provide an energy beam 144 that becomes incident upon a build point located at (X1_{B},Y5_{B}). As the energy beams 144 propagate across the build plane 130 and/or the build array 502, for example, with relative motion between the build plane 130 and the plurality of energy beams 144, and/or with relative motion between the irradiation device 142 and the build plane 130, the mapping relationship between the plurality of diode emitters 304 of the one or more laser diode arrays 302 and the build array 502 may increment. The mapping relationship may increment such that at a first increment, a first diode emitter 304 located at a first position of the one or more laser diode arrays 302 may provide a first energy beam 144 that becomes incident upon a first build point 504 in the build array 502, and at a second increment, the first diode emitter 304 located at the first position in the one or more laser diode arrays 302 may provide a second energy beam 144 that becomes incident upon a second build point 504 in the build array 502. For example, at a first increment, a diode emitter 304 located at (X1_{D},Y1_{D}) may provide an energy beam 144 that becomes incident upon a build point located at (X5_{B},Y1_{B}), and/or at a second increment the diode emitter 304 located at (X1_{D},Y1_{D}) may provide an energy beam 144 that becomes incident upon a build point located at (X6_{B},Y1_{B}). Additionally, or in the alternative, at a first increment, a diode emitter 304 located at (X5_{D},Y5_{D}) may provide an energy beam 144 that becomes incident upon a build point located at (X1_{B},Y5_{B}), and/or at a second increment, a diode emitter 304 located at (X5_{D},Y5_{D}) may provide an energy beam 144 that becomes incident upon a build point located at (X2_{B},Y5_{B}).

Respective build points 504 may receive irradiation from a plurality of energy beams 144 respectively corresponding to a plurality of diode emitters 304. The plurality of energy beams 144 may propagate incrementally across the build array such that the plurality of build points receive irradiation from at least some of the plurality of energy beams 144 with relative motion between the plurality of energy beams 144 and the build plane 130, and/or with relative motion between the irradiation device 142 and the build plane 130. Additionally, or in the alternative, the mapping of the plurality of diode emitters 304 to the build points 504 may increment with relative motion between the plurality of energy beams 144 and the build plane 130, and/or with relative motion between the irradiation device 142 and the build plane 130. The plurality of build points 504 may receive irradiation from at least some of the plurality of energy beams 144 corresponding to respective ones of the plurality of diode emitters 304 in a respective column. For example, a build point 504 in column (Y2_{B}) of the build array 502 may receive irradiation from a plurality of energy beams corresponding to a plurality of diode emitters 304 in column (Y2_{D}) of the one or more laser diode arrays 302. Additionally, or in the alternative, respective ones of the plurality of diode emitters 304 in a respective column (e.g., column Y2_{D}) may respectively provide a fraction of the total energy imparted to a respective build point 504 (e.g., a build point 504 in column Y2_{B}). For example, respective ones of the plurality of diode emitters 304 in a respective column of the one or more laser diode arrays 302 may respectively provide a pro-rata portion of the total energy imparted to a respective build point 504. Additionally, or in the alternative, respective ones of the plurality of diode emitters 304 in a respective column of the one or more laser diode arrays 302 may respectively provide a weighted portion of the total energy imparted to a respective build point 504. The weighted portion may differ as between respective ones of the plurality of diode emitters 304 in the respective column of the one or more laser diode arrays 302.

As depicted in FIG. 8A, the beam spots 322 on the respective build points 504 are shown with increasing size to illustrate an increasing proportion of energy imparted to the respective build points 504 as the plurality of energy beams 144 propagate across the build array 502, for example, with relative motion between the irradiation device 142 and the build plane 130. The total number of diode emitters 304 that provide a corresponding energy beam 144 to a respective build point 504 may be selected based at least in part on the total quantity of energy to be imparted to the respective build point 504. By way of example, five plurality of diode emitters 304 may sequentially provide a corresponding energy beam 144 that imparts about twenty percent (20%) of the total energy imparted to the respective build point 504. As shown in FIG. 8A, the build points 504 located at (X5_{B},Y1_{B}) through (X5_{B},Y5_{B}) of the build array 502 may receive irradiation from an energy beam 144 corresponding to the diode emitters 304 respectively located at (X1_{D},Y1_{D}) through (X1_{D},Y5_{D}) of the one or more laser diode arrays 302. In some embodiments, the irradiation imparted to the respective build points 504 located at (X5_{B},Y1_{B}) through (X5_{B},Y5_{B}) of the build array 502 at the point of the irradiation sequence depicted in FIG. 8A may represent about twenty percent (20%) of the total energy to be imparted to the respective build points 504 located at (X5_{B},Y1_{B}) through (X5_{B},Y5_{B}). Additionally, or in the alternative, the build points 504 located at (X1_{B},Y1_{B}) through (X1_{B},Y5_{B}) of the build array 502 may receive irradiation sequentially from a plurality of energy beams 144 respectively corresponding to the diode emitter 304 located at (X1_{D},Y1_{D}) through (X5_{D},Y5_{D}) of the one or more laser diode arrays 302. For example, the build point 504 located at (X1_{B},Y1_{B}) may receive irradiation sequentially from a plurality of energy beams 144 respectively corresponding to the diode emitter 304 located at (X1_{D},Y1_{D}) through (X5_{D},Y1_{D}) of the one or more laser diode arrays 302. Likewise, the build point 504 located at (X1_{B},Y5_{B}) may receive irradiation sequentially from a plurality of energy beams 144 respectively corresponding to the diode emitter 304 sequentially located at (X1_{D},Y5_{D}) through (X5_{D},Y5_{D}) of the one or more laser diode arrays 302. In some embodiments, the irradiation imparted to the respective build points 504 located at (X1_{B},Y1_{B}) through (X1_{B},Y5_{B}) of the build array 502 at the point of the irradiation sequence depicted in FIG. 8A may represent about one-hundred percent (100%) of the total energy to be imparted to the respective build points 504 located at (X5_{B},Y1_{B}) through (X5_{B},Y5_{B}). For example, as shown, a respective column of diode emitters 304 may provide an energy beam 144 that imparts a respective twenty percent (20%) of the total energy imparted to the respective build point 504. In some embodiments, the proportion of energy imparted to a build point 504 by a respective diode emitter 304 may be from about 0.01% to about 50%, such as from about 0.01% to about 20%, such as from about 0.1% to about 20%, such as from about 1% to about 10%, such as from about 1% to about 5%, such as from about 10% to about 20%, or such as from about 20% to about 50%.

FIGS. 8B-8G depict a further exemplary irradiation sequence. The irradiation sequence depicted in FIGS. 8B-8G may represent a subsequent portions of the exemplary irradiation sequence depicted in FIG. 8A. For example, FIG. 8B may depict a side view of a portion of the irradiation sequence depicted in FIG. 8A corresponding to column (Y2_{D}) of the one or more laser diode arrays 302 and column (Y2_{B}) of the build array 502. As shown in FIGS. 8B-8G, relative movement between the irradiation device 142 and the build plane 130 and/or build array 502 may include the irradiation device moving from right to left and/or the build plane 130 moving from left to right. The build points 504 may receive a sequential dose of irradiation from a plurality of energy beams 144 respectively corresponding to a column of diode emitters 304. The plurality of diode emitters 304 included in the column that provide the corresponding plurality of energy beams 144 may be adjacent to one another and/or spaced apart from one another. The plurality of energy beams 144 corresponding to a respective column of diode emitters 304 may become incident upon respective ones of a plurality of build points 504 in sequence, for example, with relative movement between the irradiation device 142 and the build plane 130 and/or build array 502. The build points 504 shown in FIGS. 8B-8G are shaded to represent a proportion of irradiation relieved by the sequence of energy beams 144 becoming incident upon the respective build point 504.

At a point in the irradiation sequence depicted in FIG. 8B, the one or more laser diode arrays 302 and the build array 502 may be mapped or coordinated to one another, for example, such that the plurality of diode emitters 304 located at (X1_{D},Y2_{D}) through (X5_{D},Y2_{D}) may be mapped or coordinated with the build points 504 respectively located at (X5_{B},Y2_{B}) through (X1_{B},Y2_{B}). The build point 504 located at (X5_{B},Y2_{B}) of the build array 502 may receive irradiation from an energy beam 144 corresponding to the diode emitter 304 located at (X1_{D},Y2_{D}) of the one or more laser diode arrays 302. The build point 504 located at (X4_{B},Y2_{B}) of the build array 502 may receive irradiation from an energy beam 144 corresponding to the diode emitter 304 located at (X2_{D},Y2_{D}) of the one or more laser diode arrays 302 and may have previously received irradiation from an energy beam 144 corresponding to the diode emitter 304 located at (X1_{D},Y2_{D}) of the one or more laser diode arrays 302. The build point 504 located at (X3_{B},Y2_{B}) of the build array 502 may receive irradiation from an energy beam 144 corresponding to the diode emitter 304 located at (X3_{D},Y2_{D}) of the one or more laser diode arrays 302, and may have previously received irradiation from an energy beam 144 corresponding to the diode emitter 304 located at (X2_{D},Y2_{D}) of the one or more laser diode arrays 302 and from an energy beam 144 corresponding to the diode emitter 304 located at (X1_{D},Y2_{D}) of the one or more laser diode arrays 302. The build point 504 located at (X2_{B},Y2_{B}) of the build array 502 may receive irradiation from an energy beam 144 corresponding to the diode emitter 304 located at (X4_{D},Y2_{D}) of the one or more laser diode arrays 302, and may have previously received irradiation from an energy beam 144 corresponding to the diode emitter 304 located at (X3_{D},Y2_{D}) of the one or more laser diode arrays 302, from an energy beam 144 corresponding to the diode emitter 304 located at (X2_{D},Y2_{D}) of the one or more laser diode arrays 302, and from an energy beam 144 corresponding to the diode emitter 304 located at (X1_{D},Y2_{D}) of the one or more laser diode arrays 302. The build point 504 located at (X1_{B},Y2_{B}) of the build array 502 may receive irradiation from an energy beam 144 corresponding to the diode emitter 304 located at (X5_{D},Y2_{D}) of the one or more laser diode arrays 302, and may have previously received irradiation from an energy beam 144 corresponding to the diode emitter 304 located at (X4_{D},Y2_{D}) of the one or more laser diode arrays 302, from an energy beam 144 corresponding to the diode emitter 304 located at (X3_{D},Y2_{D}) of the one or more laser diode arrays 302, from an energy beam 144 corresponding to the diode emitter 304 located at (X2_{D},Y2_{D}) of the one or more laser diode arrays 302, and from an energy beam 144 corresponding to the diode emitter 304 located at (X1_{D},Y2_{D}) of the one or more laser diode arrays 302.

As shown in FIG. 8C, with relative movement between the irradiation device 142 and the build plane 130 and/or build array 502, mapping between the plurality of diode emitters 304 of the one or more laser diode arrays 302 and the build points 504 of the build array may increment from the point in the irradiation sequence depicted in FIG. 8_{B}, for example, such that the plurality of diode emitters 304 located at (X1_{D},Y2_{D}) through (X5_{D},Y2_{D}) may be mapped or coordinated with the build points 504 respectively located at (X6_{B},Y2_{B}) through (X2_{B},Y2_{B}). At the point in the irradiation sequence depicted in FIG. 8C, the build point 504 located at (X6_{B},Y2_{B}) may receive irradiation from a first energy beam 144 corresponding to the diode emitter 304 located at (X1_{D},Y2_{D}) of the one or more laser diode arrays 302. The irradiation from the first energy beam 144 corresponding to the diode emitter 304 located at (X1_{D},Y2_{D}) of the one or more laser diode arrays 302 may be the first or initial dose of irradiation received by the build point 504 located at (X6_{B},Y2_{B}) for the irradiation sequence depicted in FIGS. 8B-8G. Additionally, or in the alternative, the build point 504 located at (X2_{B},Y2_{B}) may receive irradiation from a fifth energy beam 144 corresponding to the diode emitter 304 located at (X5_{D},Y2_{D}) of the one or more laser diode arrays 302. The irradiation from the fifth energy beam 144 corresponding to the diode emitter 304 located at (X5_{D},Y2_{D}) of the one or more laser diode arrays 302 may be the fifth or concluding dose of irradiation received by the build point 504 located at (X2_{B},Y2_{B}) for the irradiation sequence depicted in FIGS. 8B-8G. The build points 504 located at (X5_{B},Y2_{B}) through (X3_{B},Y2_{B}) of the build array 502 may respectively receive irradiation from energy beams 144 corresponding to the plurality of diode emitters 304 respectively located at (X2_{D},Y2_{D}) through (X4_{D},Y2_{D}) of the micromirror array, which may represent the second, third, and fourth dose of irradiation received by the build points 504 located at (X5_{B},Y2_{B}) through (X3_{B},Y2_{B}) of the build array 502. The build point 504 located at (X1_{B},Y2_{B}) may receive no irradiation, having previously received irradiation from a sequence of energy beams 144 corresponding to the plurality of diode emitters 304 respectively located at (X1_{D},Y2_{D}) through (X5_{D},Y2_{D}).

The irradiation sequence may similarly increment as shown, for example, in FIGS. 8D through 8G, with relative movement between the irradiation device 142 and the build plane 130 and/or build array 502. Mapping between the plurality of diode emitters 304 of the one or more laser diode arrays 302 and the build points 504 of the build array may increment from the respective preceding point in the irradiation sequence, for example, to a point in the irradiation sequence shown in FIG. 8G, such that the plurality of diode emitters 304 located at (X1_{D},Y2_{D}) through (X5_{D},Y2_{D}) may be mapped or coordinated with the build points 504 respectively located at (X10_{B},Y2_{B}) through (X4_{B},Y2_{B}). At the point in the irradiation sequence depicted in FIG. 8G, the build point 504 located at (X5_{B},Y2_{B}) may have received irradiation from a complete sequence of energy beams 144 respectively corresponding to a column of diode emitters 304 from the one or more laser diode arrays 302. For example, the build point 504 located at (X5_{B},Y2_{B}) may have received a first dose of irradiation from a first energy beam 144 corresponding to a first diode emitter 304 at the point in the irradiation sequence depicted in FIG. 8B. Additionally, or in the alternative, the build point 504 located at (X5_{B},Y2_{B}) may have received a second dose of irradiation from a second energy beam 144 corresponding to a second diode emitter 304 at the point in the irradiation sequence depicted in FIG. 8C, a third dose of irradiation from a third energy beam 144 corresponding to a third diode emitter 304 at the point in the irradiation sequence depicted in FIG. 8D, a fourth dose of irradiation from a fourth energy beam 144 corresponding to a fourth diode emitter 304 at the point in the irradiation sequence depicted in FIG. 8E, and/or a fifth dose of irradiation from a fifth energy beam 144 corresponding to a fifth diode emitter 304 at the point in the irradiation sequence depicted in FIG. 8F.

As shown in FIG. 8G, at least some of the build points 504 in the build array 502 may receive no irradiation. For example, the build point 504 located at (X5_{B},Y2_{B}) of the build array 502 may receive no irradiation at the point in the irradiation sequence depicted in FIG. 8G, having already received irradiation from a sequence of energy beams 144 sufficient to provide a specified intensity and/or power density for irradiating the build point 504 according to irradiation instructions carried out by the control system 104 and/or the optical modulator. The irradiation received by the build point 504 located at (X5_{B},Y2_{B}) of the build array 502 may correspond to a complete sequence of energy beams 144 from the plurality of diode emitters 304 in the corresponding column. Additionally, or in the alternative, the build point 504 may receive no irradiation when, irradiation instructions do not include instructions to irradiate the build point 504. For example, the build point 504 may not define part of an object 114 being additively manufactured, and/or additional irradiation may be unnecessary at the build point 504. As shown in FIG. 8G, the build point 504 located at (X6_{B},Y2_{B}) may have received irradiation from a sequential plurality of energy beams 144 respectively corresponding to the plurality of diode emitters 304 located at (X1_{D},Y2_{D}) through (X5_{D},Y2_{D}). The build point 504 located at (X7_{B},Y2_{B}) may have received irradiation from a sequential plurality of energy beams 144 respectively corresponding to the plurality of diode emitters 304 located at (X1_{D},Y2_{D}) through (X4_{D},Y2_{D}). The build point 504 located at (X8_{B},Y2_{B}) may have received irradiation from a sequential plurality of energy beams 144 respectively corresponding to the plurality of diode emitters 304 located at (X1_{D},Y2_{D}) through (X3_{D},Y2_{D}). The build point 504 located at (X9_{B},Y2_{B}) may have received irradiation from a sequential plurality of energy beams 144 respectively corresponding to the plurality of diode emitters 304 located at (X1_{D},Y2_{D}) through (X2_{D},Y2_{D}). The build point 504 located at (X10_{B},Y2_{B}) may have received irradiation from an initial energy beam 144 in a sequential plurality of energy beams 144, with the initial energy beam 144 corresponding to the diode emitter 304 located at (X1_{D},Y2_{D}).

As depicted in FIGS. 8A-8G, each build point 504 in a build array 502 may receive irradiation from a sequential plurality of energy beams 144 respectively corresponding to a column of diode emitters 304 from one or more laser diode arrays 302. Build points 504 that are not intended to be irradiated, such as build points 504 that are located outside of a build region for a respective layer of a three-dimensional object 114, may be bypassed by the sequential plurality of energy beams 144. The sequential plurality of energy beams 144 may irradiated a build point 504 and/or may bypass a build point 504, for example, based at least in part on a build file that defines build points 504 of a build array 502 to be irradiated in order to additively manufacture a three-dimensional object 114. Irradiation instructions may cause respective ones of the plurality of diode emitters 304 to emit an energy beam 144 based at least in part on the build file.

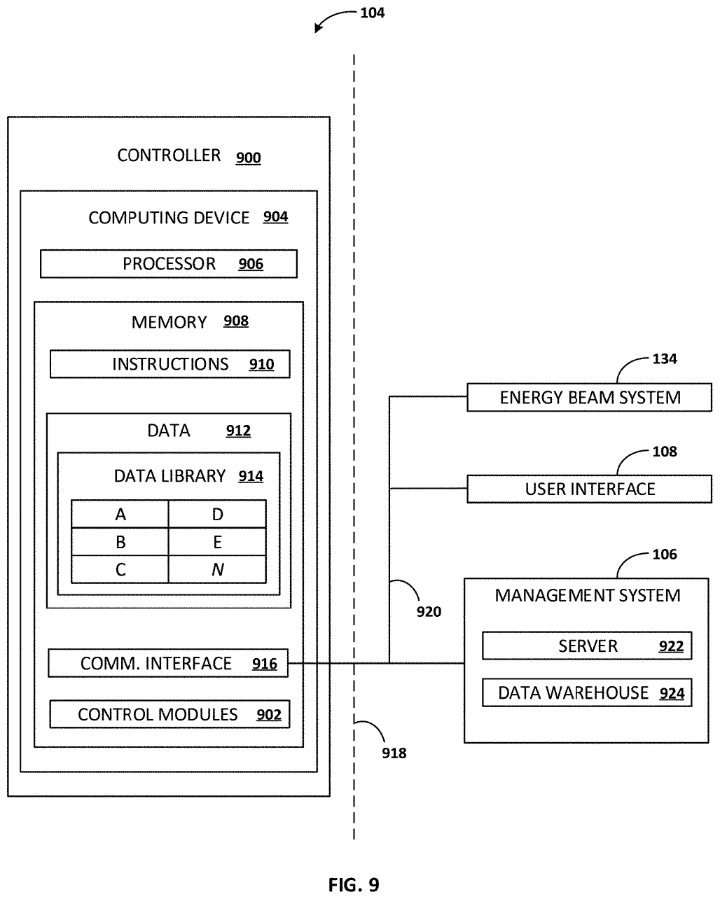

Now turning to FIG. 9, and exemplary control system 104 will be described. A control system 104 may be configured to perform one or more control operations associated with an additive manufacturing system 100 and/or an additive manufacturing machine 102. The control operations may include, one or more control commands may be configured to control operations of an energy beam system 134, including, for example, control operations of one or more irradiation devices 142 and/or one or more beam generation devices 300, laser diode arrays 302, and/or positioning systems 150.

As shown in FIG. 9, an exemplary control system 104 may include a controller 900. The controller may include one or more control modules 902 configured to cause the controller 900 to perform one or more control operations. The one or more control modules 902 may include control logic executable to provide control commands configured to control one or more controllable components associated with an additive manufacturing machine 102, such as controllable components associated with an energy beam system 134, one or more irradiation devices 142 and/or one or more beam generation devices 300, laser diode arrays 302, and/or positioning systems 150. For example, a control module 902 may be configured to provide one or more control commands executable to control operation of one or more components of an irradiation device 142, such as operation of a beam generation device 300, a laser diode array 302, and/or a positioning system 150.

The controller 900 may be communicatively coupled with an additive manufacturing machine 102. The controller 900 may be communicatively coupled with one or more components of an additive manufacturing machine 102, such as one or more components of an energy beam system 134 and/or an irradiation device 142, such as a beam generation device 300, a laser diode array 302, and/or a positioning system 150, and/or any one or more other elements thereof. The controller 900 may also be communicatively coupled with a management system 106 and/or a user interface 108.

The controller 900 may include one or more computing devices 904, which may be located locally or remotely relative to an additive manufacturing machine 102, an energy beam system 134, and/or an irradiation device 142. The one or more computing devices 904 may include one or more processors 906 and one or more memory devices 908. The one or more processors 906 may include any suitable processing device, such as a microprocessor, microcontroller, integrated circuit, logic device, and/or other suitable processing device. The one or more memory devices 908 may include one or more computer-readable media, including but not limited to non-transitory computer-readable media, RAM, ROM, hard drives, flash drives, and/or other memory devices 908.

As used herein, the terms “processor” and “computer” and related terms, such as “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. A memory device 908 may include, but is not limited to, a non-transitory computer-readable medium, such as a random access memory (RAM), and computer-readable nonvolatile media, such as hard drives, flash memory, and other memory devices. Alternatively, a floppy disk, a compact disc-read only memory (CD-ROM), a magneto-optical disk (MOD), and/or a digital versatile disc (DVD) may also be used.

As used herein, the term “non-transitory computer-readable medium” is intended to be representative of any tangible computer-based device implemented in any method or technology for short-term and long-term storage of information, such as, computer-readable instructions, data structures, program modules and sub-modules, or other data in any device. The methods described herein may be encoded as executable instructions embodied in a tangible, non-transitory, computer readable media, including, without limitation, a storage device and/or a memory device. Such instructions, when executed by a processor, cause the processor to perform at least a portion of the methods described herein. Moreover, as used herein, the term “non-transitory computer-readable medium” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The one or more memory devices 908 may store information accessible by the one or more processors 906, including computer-executable instructions 910 that can be executed by the one or more processors 906. The instructions 910 may include any set of instructions which when executed by the one or more processors 906 cause the one or more processors 906 to perform operations, including irradiation operations, calibration operations, and/or additive manufacturing operations. Additionally, or in the alternative, the instructions, when executed by the one or more processors 906, may cause the one or more processors 906 to perform an irradiation sequence as described herein.

The memory devices 908 may store data 912 accessible by the one or more processors 906. The data 912 can include current or real-time data 912, past data 912, or a combination thereof. The data 912 may be stored in a data library 914. As examples, the data 912 may include data 912 associated with or generated by an additive manufacturing system 100 and/or an additive manufacturing machine 102, including data 912 associated with or generated by the controller 900, an additive manufacturing machine 102, an energy beam system 134, one or more irradiation devices 142, one or more beam generation devices 300, one or more laser diode arrays 302, one or more positioning systems 150, a management system 106, a user interface 108, and/or a computing device 904, such as operational data 912 and/or calibration data 912 pertaining thereto. The data 912 may also include other data sets, parameters, outputs, information, associated with an additive manufacturing system 100 and/or an additive manufacturing machine 102.

The one or more computing devices 904 may also include a communication interface 916, which may be used for communications with a communication network 918 via wired or wireless communication lines 920. The communication interface 916 may include any suitable components for interfacing with one or more network(s), including for example, transmitters, receivers, ports, controllers, antennas, and/or other suitable components. The communication interface 916 may allow the computing device 904 to communicate with various nodes on the communication network 918, such as nodes associated with the additive manufacturing machine 102, the energy beam system 134, the one or more irradiation devices 142, the one or more beam generation devices 300, one or more laser diode arrays 302, one or more positioning systems 150, the management system 106, and/or the user interface 108. The communication network 918 may include, for example, a local area network (LAN), a wide area network (WAN), SATCOM network, VHF network, a HF network, a Wi-Fi network, a WiMAX network, a gatelink network, and/or any other suitable communication network 918 for transmitting messages to and/or from the controller 900 across the communication lines 920. The communication lines 920 of communication network 918 may include a data bus or a combination of wired and/or wireless communication links.

The communication interface 916 may allow the computing device 904 to communicate with various components of an additive manufacturing system 100 and/or an additive manufacturing machine 102 communicatively coupled with the communication interface 916 and/or communicatively coupled with one another. The communication interface 916 may additionally or alternatively allow the computing device 904 to communicate with the management system 106 and/or the user interface 108. The management system 106 may include a server 922 and/or a data warehouse 924. As an example, at least a portion of the data 912 may be stored in the data warehouse 924, and the server 922 may be configured to transmit data 912 from the data warehouse 924 to the computing device 904, and/or to receive data 912 from the computing device 904 and to store the received data 912 in the data warehouse 924 for further purposes. The server 922 and/or the data warehouse 924 may be implemented as part of a control system 104 and/or as part of the management system 106.

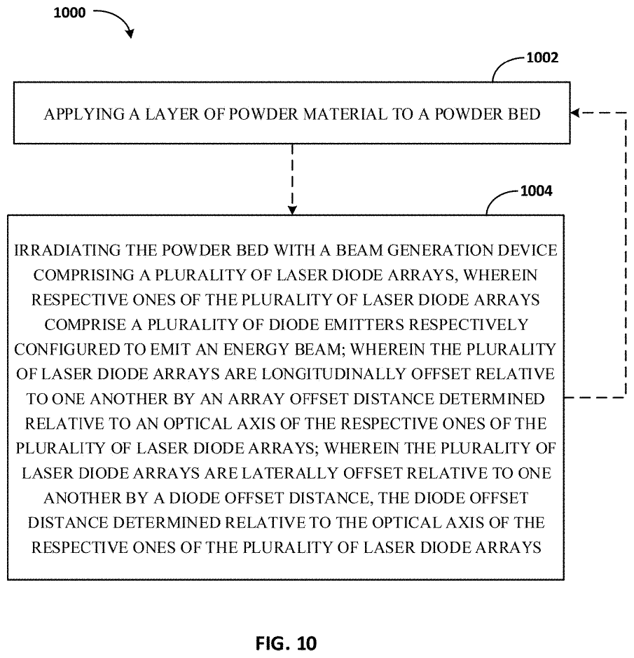

Now turning to FIG. 10, exemplary methods 1000 of additively manufacturing a three-dimensional object will be described. Exemplary methods 1000 may be performed at least in part by a control system 104, a controller 900, and/or one or more control modules 902 associated with the control system 104 and/or the controller 900. Additionally, or in the alternative, exemplary methods 1000 may be performed at least in part by an additive manufacturing system and/or an additive manufacturing machine 102, for example, by a control system 104 and/or a controller 900 associated therewith.

As shown in FIG. 10, an exemplary method 1000 may include, at block 1002, applying a layer of powder material 120 to a powder bed 138. At block 1004, an exemplary method may include irradiating the powder bed 138 with a beam generation device 300 that includes a plurality of laser diode arrays 302. Respective ones of the plurality of laser diode arrays 302 may include a plurality of diode emitters 304 respectively configured to emit an energy beam 144. The plurality of laser diode arrays 302 may be longitudinally offset relative to one another by an array offset distance (O_{A}). The array offset distance (O_{A}) may be determined relative to an optical axis (A) of the respective ones of the plurality of laser diode arrays 302. The plurality of laser diode arrays 302 may be laterally offset relative to one another by a diode offset distance (O_{D}). The diode offset distance (O_{D}) may be determined relative to the optical axis (A) of the respective ones of the plurality of laser diode arrays 302. The exemplary method 1000 may be repeated for any desired number of layers of powder material 120.

In some embodiments, the exemplary method 1000 may include irradiating the powder bed 138 with a first plurality of energy beams 144 corresponding to a first row of diode emitters 304 and irradiating the powder bed 138 with a second plurality of energy beams 144 corresponding to a second row of diode emitters 304. The first plurality of energy beams 144 may provide a corresponding first plurality of beam spots 322 incident upon a build array 502 defined by the powder bed 138 and the second plurality of energy beams 144 may provide a corresponding second plurality of beam spots 322 incident upon the powder bed 138. The first plurality of beam spots 322 and the second plurality of beam spots 322 may be arranged in a pattern or sequence such that beams spots 322 that become incident upon laterally adjacent build points 504 of the build array 502 are longitudinally offset from one another.

Additionally, or in the alternative, in some embodiments, an exemplary method 1000 may include irradiating the powder bed 138 with a plurality of rows of diode emitters 304, for example, as described with reference to FIGS. 8A-8G. An exemplary method 1000 may include sequentially irradiating respective build points 504 of the build array 502 from a plurality of energy beams 144. In some embodiments, respective ones of the plurality of energy beams 144 that become incident upon a respective build point 504 may be respectively emitted by a diode emitter 304 corresponding to longitudinally adjacent ones of the plurality of rows of diode emitters 304. For example, a build point 504 may receive irradiation from a first energy beam 144 corresponding to a first diode emitter 304 from a first row, followed by irradiation from a second energy beam 144 from a second diode emitter 304 from a second row, followed by irradiation from a third energy beam 144 from a third diode emitter 304 from a third row, and so forth.

Further aspects of the presently disclosed subject matter are provided by the following clauses:

1. An irradiation device for additively manufacturing three-dimensional objects, the irradiation device comprising: a beam generation device comprising a plurality of laser diode arrays, wherein respective ones of the plurality of laser diode arrays comprise a plurality of diode emitters respectively configured to emit an energy beam; wherein the plurality of laser diode arrays are longitudinally offset relative to one another; and wherein the plurality of laser diode arrays are laterally offset relative to one another.

2. The irradiation device of any clause herein, wherein the plurality of laser diode arrays are longitudinally offset relative to one another by an array offset distance determined relative to an optical axis of the respective ones of the plurality of laser diode arrays.

3. The irradiation device of any clause herein, wherein the plurality of laser diode arrays includes at least three laser diode arrays, and wherein the array offset distance is uniform as between respective ones of the plurality of laser diode arrays.

4. The irradiation device of any clause herein, wherein the plurality of laser diode arrays includes at least three laser diode arrays, and wherein the array offset distance differs as between respective ones of the plurality of laser diode arrays.

5. The irradiation device of any clause herein, wherein the plurality of laser diode arrays are laterally offset relative to one another by a diode offset distance, the diode offset distance determined relative to an optical axis of the respective ones of the plurality of laser diode arrays

6. The irradiation device of any clause herein, wherein the plurality of laser diode arrays includes at least three laser diode arrays, and wherein the diode offset distance is uniform as between respective ones of the plurality of laser diode arrays.

7. The irradiation device of any clause herein, wherein the plurality of laser diode arrays includes at least three laser diode arrays, and wherein the diode offset distance differs as between respective ones of the plurality of laser diode arrays.

8. The irradiation device of any clause herein, wherein the plurality of laser diode arrays respectively emit a plurality of energy beams, respective ones of the plurality of energy beams emitted from corresponding ones of the plurality of diode emitters; wherein the plurality of energy beams provide a corresponding plurality of beam spots incident upon a build array defined by a powder bed disposed below the irradiation device, the plurality of beam spots arranged in a pattern or sequence such that beams spots that become incident upon laterally adjacent build points of the build array are longitudinally offset from one another.

9. The irradiation device of any clause herein, wherein at least some beams spots are longitudinally offset from one another in an alternating pattern or sequence.

10. The irradiation device of any clause herein, wherein plurality of energy beams provide a linear scan field comprising a first plurality of beam spots laterally spaced apart from one another followed by a second plurality of beam spots laterally spaced apart from one another; wherein the first plurality of beam spots and the second plurality of beam spots are longitudinally offset from one another with reference to a longitudinal axis of the build array, and wherein the first plurality of beam spots and the second plurality of beam spots are laterally offset from one another with reference to a transverse axis of the build array.

11. The irradiation device of any clause herein, wherein a first one of the plurality of laser diode arrays is configured to emit a first plurality of energy beams, and a second one of the plurality of laser diode arrays is configured to emit a second plurality of energy beams, wherein respective ones of the first plurality of energy beams are laterally offset from respective ones of the second plurality of energy beams by a beam offset distance determined with reference to a transverse axis of the build array.

12. The irradiation device of any clause herein, wherein the first plurality of energy beams provide a first plurality of beam spots that become incident upon and propagate across the build array as a first row and wherein the second plurality of energy beams provide a second plurality of beam spots that become incident upon and propagate across the build array as a second row.

13. The irradiation device of any clause herein, wherein the first row and the second row are longitudinally offset from one another by a distance of at least one pixel width of the build array, the pixel width defined between build points of the build array.

14. The irradiation device of any clause herein, wherein the plurality of diode emitters are spaced apart from one another by a diode pitch, and wherein the diode offset distance is less than the diode pitch.

15. The irradiation device of any clause herein, wherein the diode offset distance is from 10% of the diode pitch to 90% of the diode pitch.

16. The irradiation device of any clause herein, wherein the plurality of diode emitters have a diode width, and wherein the diode offset distance is equal to or greater than the diode width.

17. The irradiation device of any clause herein, wherein the plurality of diode emitters are spaced apart from one another by a diode pitch, and wherein adjacent beam spots have a beam pitch that is less than the diode pitch.

18. The irradiation device of any clause herein, wherein the plurality of beam spots incident upon the build array have a spacing corresponding to a pixel width defined between build points of the build array, wherein the plurality of diode emitters are spaced apart from one another by a diode pitch, and wherein the pixel width is smaller than the diode pitch.

19. The irradiation device of any clause herein, wherein the pixel width of the build array is from 1 micrometer to 500 micrometers.

20. The irradiation device of any clause herein, wherein the irradiation device is configured to provide beam spots that have a width of from 1 micrometer to 500 micrometers.

21. The irradiation device of any clause herein, wherein the plurality of laser diode arrays are configured to provide an energy density per beam spot of from 0.1 W/cm² to 500 W/cm².

22. The irradiation device of any clause herein, wherein the plurality of laser diode arrays have a pulse frequency of from 10 MHz to 100 GHz.

23. The irradiation device of any clause herein, wherein the plurality of laser diode arrays are configured to emit energy beams that have a wavelength in the ultraviolet spectrum, the visible spectrum, the near-infrared spectrum, or the infrared spectrum.

24. The irradiation device of any clause herein, the plurality of laser diode arrays respectively comprise a plurality of rows of diode emitters.

25. The irradiation device of any clause herein, wherein a cross-sectional dimension of respective ones of the plurality of beam spots is determined based at least in part on a Lagrange invariant.

26. The irradiation device of any clause herein, wherein the Lagrange invariant is from about 2.5 micrometers to about 90 micrometers.

27. The irradiation device of any clause herein, comprising: a beam conditioning assembly be disposed downstream from the beam generation device, the beam conditioning assembly comprising one or more collimating lenses, wherein the one or more collimating lenses are configured to collimate respective ones of a plurality of energy beams emitted by corresponding ones of the plurality of diode emitters such that the plurality of beam spots corresponding to the plurality of energy beams become incident upon the build array arranged in the pattern or sequence.

28. The irradiation device of any clause herein, wherein 1 the plurality of diode emitters are spaced apart from one another by a diode pitch of from 25 micrometers to 250 micrometers.

29. The irradiation device of any clause herein, wherein the plurality of diode emitters have a diode width of from 50 micrometers to 300 micrometers.

30. The irradiation device of any clause herein, wherein the irradiation device is configured to provide a plurality of energy beams with an M² value of from 1.05 to 2.0.

31. The irradiation device of any clause herein, comprising: a beam conditioning assembly be disposed downstream from the beam generation device, the beam conditioning assembly comprising one or more lenses, the one or more lenses comprising a fast-axis collimating lens and/or a slow-axis collimating lens.

32. The irradiation device of any clause herein, wherein the beam conditioning assembly comprises a beam homogenizer.

33. The irradiation device of any clause herein, wherein the plurality of diode emitters are spaced apart from one another by a diode pitch, and wherein the one or more lenses of the beam conditioning assembly are configured and arranged to provide a plurality of energy beams that are spaced apart from one another by a beam pitch that is less than or equal to the diode pitch.

34. The irradiation device of any clause herein, wherein the beam pitch is from 10% to 95% of the diode pitch.

35. The irradiation device of any clause herein, comprising: a beam focusing assembly disposed downstream from the beam conditioning assembly, the beam focusing assembly comprising one or more focusing lenses.

36. The irradiation device of any clause herein, wherein the one or more focusing lenses comprises a fast-axis focusing lens and/or a slow-axis focusing lens.

37. The irradiation device of any clause herein, comprising: a positioning system, wherein the irradiation device is mounted to the positioning system, wherein the positioning system is configured to move the irradiation device.

38. The irradiation device of any clause herein, wherein the positioning system comprises a plurality of irradiation devices mounted thereto, respective ones of the plurality of irradiation devices configured according to claim 1.

39. The irradiation device of any clause herein, wherein the positioning system is configured to move the irradiation device at a rate of from 1 millimeters per second to 10 millimeters per second.

40. The irradiation device of any clause herein, wherein the plurality of diode emitters corresponding to respective ones of the plurality of laser diode arrays comprises one or more rows of diode emitters.

41. The irradiation device of any clause herein, wherein the plurality of diode emitters have a diode width and wherein the plurality of diode emitters are spaced apart from one another by a diode pitch, and wherein the number of rows of diode emitters is proportional to a ratio of the diode width to the diode pitch.

42. The irradiation device of any clause herein, the plurality of laser diode arrays together define a plurality of rows of diode emitters, wherein respective ones of the plurality of rows of diode emitters are laterally offset relative to one another by the diode offset distance (O_{D}).

43. The irradiation device of any clause herein, wherein the number of rows of diode emitters is defined by the following relationship: N=(P_{D}/w_{D})//k_{D}, where k_{D} is a diode overlap factor and N is the number of rows of diode emitters, P_{D} is the diode pitch, and w_{D} is the diode width.

44. The irradiation device of any clause herein, wherein the beam offset distance is defined by the following relationship: O_{B}=O_{D}·k_{B}, where O_{B} is the beam offset distance, O_{D} is the diode offset distance, k_{B} is a focus factor of respective ones of the plurality of energy beams.

45. The irradiation device of any clause herein, wherein a pixel width of the build array is defined by the following relationship: w_{P}=(P_{D}/N)/k_{P}, where w_{P} is the pixel width, P_{D} is the diode pitch, N is the number of rows of diode emitters, and k_{P} is a pixel overlap factor (k_{P}).

46. The irradiation device of any clause herein, wherein the plurality of diode emitters corresponding to respective ones of the plurality of laser diode arrays define a plurality of rows of diode emitters.

47. The irradiation device of any clause herein, wherein the plurality of diode emitters are spaced apart from one another by a diode pitch, and wherein adjacent ones of the plurality of rows of diode emitters are laterally offset incrementally across a distance corresponding to the diode pitch.

48. The irradiation device of any clause herein, wherein the plurality of diode emitters are spaced apart from one another by a diode pitch, and the plurality of rows of diode emitters are laterally offset in an alternating or asynchronous pattern across a diode pitch (P_{D}).

49. The irradiation device of any clause herein, wherein the plurality of diode emitters have a diode width, and wherein the alternating or asynchronous pattern comprises adjacent ones of the plurality of rows of diode emitters being laterally offset by at least twice the diode width.

50. The irradiation device of any clause herein, comprising: an irradiation carriage, wherein the plurality of laser diode arrays are coupled to the irradiation carriage; and one or more actuators, wherein a respective one of the one or more actuators is configured to adjust a position of at least one of the plurality of laser diode arrays coupled to the irradiation carriage.

51. The irradiation device of any clause herein, wherein the one or more actuators are respectively configured to provide a lateral positional adjustment and/or a longitudinal positional adjustment of the at least one of the plurality of laser diode arrays.

52. The irradiation device of any clause herein, comprising: an irradiation carriage, wherein the plurality of laser diode arrays are coupled to the irradiation carriage, wherein at least some of the plurality of laser diode arrays are arranged laterally adjacent to one another.

53. The irradiation device of any clause herein, wherein the plurality of diode emitters are spaced apart from one another by a diode pitch, and wherein respective laterally adjacent ones of the plurality of laser diode arrays are laterally spaced from one another by a distance that corresponds to a factor of the diode pitch.

54. The irradiation device of any clause herein, wherein respective ones of the plurality of laser diode arrays may have a width of from 10 millimeters to about 100 millimeters.

55. The irradiation device of any clause herein, wherein the plurality of laser diode arrays arranged laterally adjacent to one another comprising from 2 to 10 laser diode arrays arranged laterally adjacent to one another.

56. The irradiation device of any clause herein, wherein the plurality of laser diode arrays arranged laterally adjacent to one another has a scan field of from about 50 millimeters to about 1,000 millimeters.

57. The irradiation device of any clause herein, comprising: a plurality of diode array groups, the plurality of diode array groups respectively comprising at least some of the plurality of laser diode arrays; wherein the plurality of diode array groups are arranged longitudinally adjacent to one another and separated from one another by a group separation distance; wherein respective ones of the plurality diode arrays corresponding to the respective ones of the plurality of laser diode arrays belonging to a respective one of the plurality of diode array groups are longitudinally adjacent to one another and separated from one another by a row separation distance, wherein the group separation distance is larger than the row separation distance.

58. The irradiation device of any clause herein, wherein respective ones of the plurality of diode array groups are laterally offset by a group offset distance.

59. The irradiation device of any clause herein, comprising: a plurality of diode array sets, the plurality of diode array sets respectively comprising at least some of the plurality of diode array groups; wherein the plurality of diode array sets are arranged longitudinally adjacent to one another and separated from one another by a set separation distance; wherein the set separation distance is larger than the group separation distance.

60. The irradiation device of any clause herein, comprising: wherein the plurality of diode array sets comprises a first diode array set and a second diode array set, wherein a corresponding one of the plurality of laser diode arrays belonging to the first diode array set is configured to exhibit one or more irradiation parameters that differs from a corresponding one of the plurality of laser diode arrays belonging to the second diode array set, the one or more irradiation parameters comprising: beam power, beam intensity, intensity profile, wavelength, spot size, and/or spot shape.

61. The irradiation device of any clause herein, comprising: a plurality of diode array sets, the plurality of diode array sets respectively comprising at least some of the plurality of diode array groups; wherein the plurality of diode array sets comprises a first diode array set and a second diode array set, wherein a corresponding one of the plurality of laser diode arrays belonging to the first diode array set is configured to impart a quantity of heat to a powder bed that differs from a corresponding one of the plurality of laser diode arrays belonging to the second diode array set.

62. The irradiation device of any clause herein, wherein the first diode array set is configured to provide pre-heating, re-melting, and/or post-treating; and wherein the second diode array set is configured to provide lasing.

63. A method of additively manufacturing a three-dimensional object, the method comprising: irradiating a powder bed with a beam generation device comprising a plurality of laser diode arrays, wherein respective ones of the plurality of laser diode arrays comprise a plurality of diode emitters respectively configured to emit an energy beam; wherein the plurality of laser diode arrays are longitudinally offset relative to one another; and wherein the plurality of laser diode arrays are laterally offset relative to one another.

64. The method of any clause herein, wherein the plurality of laser diode arrays are longitudinally offset relative to one another by an array offset distance determined relative to an optical axis of the respective ones of the plurality of laser diode arrays.

65. The method of any clause herein, wherein the plurality of laser diode arrays includes at least three laser diode arrays, and wherein the array offset distance is uniform as between respective ones of the plurality of laser diode arrays.

66. The method of any clause herein, wherein the plurality of laser diode arrays includes at least three laser diode arrays, and wherein the array offset distance differs as between respective ones of the plurality of laser diode arrays.

67. The method of any clause herein, wherein the plurality of laser diode arrays are laterally offset relative to one another by a diode offset distance, the diode offset distance determined relative to an optical axis of the respective ones of the plurality of laser diode arrays.

68. The method of any clause herein, wherein the plurality of laser diode arrays includes at least three laser diode arrays, and wherein the diode offset distance is uniform as between respective ones of the plurality of laser diode arrays.

69. The method of any clause herein, wherein the plurality of laser diode arrays includes at least three laser diode arrays, and wherein the diode offset distance differs as between respective ones of the plurality of laser diode arrays.

70. The method of any clause herein, comprising: applying a layer of powder material to the powder bed.

71. The method of any clause herein, comprising: irradiating the powder bed with a first plurality of energy beams corresponding to a first row of diode emitters and irradiating the powder bed with a second plurality of energy beams corresponding to a second row of diode emitters; wherein the first plurality of energy beams provide a corresponding first plurality of beam spots incident upon a build array defined by the powder bed and the second plurality of energy beams provide a corresponding second plurality of beam spots incident upon the powder bed; wherein the first plurality of beam spots and the second plurality of beam spots are arranged in a pattern or sequence such that beams spots that become incident upon laterally adjacent build points of the build array are longitudinally offset from one another.

72. The method of any clause herein, comprising: irradiating the powder bed with a plurality of rows of diode emitters, wherein respective build points of the build array receive irradiation sequentially from a plurality of energy beams, wherein respective ones of the plurality of energy beams that become incident upon a respective build point are respectively emitted by a diode emitter corresponding to longitudinally adjacent ones of the plurality of rows of diode emitters.

73. The method of any clause herein, wherein the method is performed using the irradiation device of any clause herein.

74. A computer-readable medium comprising computer-executable instructions, which when executed by a processor associated with an additive manufacturing machine, cause the additive manufacturing machine to perform a method comprising: irradiating a powder bed with a beam generation device comprising a plurality of laser diode arrays, wherein respective ones of the plurality of laser diode arrays comprise a plurality of diode emitters respectively configured to emit an energy beam; wherein the plurality of laser diode arrays are longitudinally offset relative to one another; and wherein the plurality of laser diode arrays are laterally offset relative to one another.

75. The computer-readable medium of any clause herein, wherein the computer-readable medium, when executed by a processor associated with an additive manufacturing machine, is configured to cause the additive manufacturing machine to perform the method of any clause herein.

This written description uses exemplary embodiments to describe the presently disclosed subject matter, including the best mode, and also to enable any person skilled in the art to practice such subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An irradiation device for additively manufacturing three-dimensional objects, the irradiation device comprising:
a beam generation device comprising a plurality of laser diode arrays, wherein respective ones of the plurality of laser diode arrays comprise a plurality of diode emitters respectively configured to emit an energy beam;
wherein the plurality of laser diode arrays are longitudinally offset relative to one another; and
wherein the plurality of laser diode arrays are laterally offset relative to one another.

2. The irradiation device of claim 1, wherein the plurality of laser diode arrays are longitudinally offset relative to one another by an array offset distance determined relative to an optical axis of the respective ones of the plurality of laser diode arrays.

3. The irradiation device of claim 1, wherein the plurality of laser diode arrays respectively emit a plurality of energy beams, respective ones of the plurality of energy beams emitted from corresponding ones of the plurality of diode emitters;
wherein the plurality of energy beams provide a corresponding plurality of beam spots incident upon a build array defined by a powder bed disposed below the irradiation device, the plurality of beam spots arranged in a pattern or sequence such that beams spots that become incident upon laterally adjacent build points of the build array are longitudinally offset from one another.

4. The irradiation device of claim 3, wherein at least some beams spots are longitudinally offset from one another in an alternating pattern or sequence.

5. The irradiation device of claim 3, wherein plurality of energy beams provide a linear scan field comprising a first plurality of beam spots laterally spaced apart from one another followed by a second plurality of beam spots laterally spaced apart from one another;
wherein the first plurality of beam spots and the second plurality of beam spots are longitudinally offset from one another with reference to a longitudinal axis of the build array, and wherein the first plurality of beam spots and the second plurality of beam spots are laterally offset from one another with reference to a transverse axis of the build array.

6. The irradiation device of claim 3, wherein a first one of the plurality of laser diode arrays is configured to emit a first plurality of energy beams, and a second one of the plurality of laser diode arrays is configured to emit a second plurality of energy beams, wherein respective ones of the first plurality of energy beams are laterally offset from respective ones of the second plurality of energy beams by a beam offset distance determined with reference to a transverse axis of the build array.

7. The irradiation device of claim 6, wherein the first plurality of energy beams provide a first plurality of beam spots that become incident upon and propagate across the build array as a first row and wherein the second plurality of energy beams provide a second plurality of beam spots that become incident upon and propagate across the build array as a second row.

8. The irradiation device of claim 1, wherein the plurality of laser diode arrays are configured to emit energy beams that have a wavelength in the ultraviolet spectrum, the visible spectrum, the near-infrared spectrum, or the infrared spectrum.

9. The irradiation device of claim 1, comprising:
a beam conditioning assembly be disposed downstream from the beam generation device, the beam conditioning assembly comprising one or more lenses, the one or more lenses comprising a fast-axis collimating lens and/or a slow-axis collimating lens.

10. The irradiation device of claim 9, wherein the beam conditioning assembly comprises a beam homogenizer.

11. The irradiation device of claim 1, comprising:
a beam focusing assembly disposed downstream from the beam conditioning assembly, the beam focusing assembly comprising one or more focusing lenses.

12. The irradiation device of claim 1, comprising:
a positioning system, wherein the irradiation device is mounted to the positioning system, wherein the positioning system is configured to move the irradiation device.

13. The irradiation device of claim 1, comprising:
an irradiation carriage, wherein the plurality of laser diode arrays are coupled to the irradiation carriage; and
one or more actuators, wherein a respective one of the one or more actuators is configured to adjust a position of at least one of the plurality of laser diode arrays coupled to the irradiation carriage.

14. The irradiation device of claim 1, wherein the one or more actuators are respectively configured to provide a lateral positional adjustment and/or a longitudinal positional adjustment of the at least one of the plurality of laser diode arrays.

15. The irradiation device of claim 1, comprising:
an irradiation carriage, wherein the plurality of laser diode arrays are coupled to the irradiation carriage, wherein at least some of the plurality of laser diode arrays are arranged laterally adjacent to one another.

16. The irradiation device of claim 1, comprising:
a plurality of diode array groups, the plurality of diode array groups respectively comprising at least some of the plurality of laser diode arrays;
wherein the plurality of diode array groups are arranged longitudinally adjacent to one another and separated from one another by a group separation distance;
wherein respective ones of the plurality diode arrays corresponding to the respective ones of the plurality of laser diode arrays belonging to a respective one of the plurality of diode array groups are longitudinally adjacent to one another and separated from one another by a row separation distance, wherein the group separation distance is larger than the row separation distance.

17. The irradiation device of claim 16, comprising:
a plurality of diode array sets, the plurality of diode array sets respectively comprising at least some of the plurality of diode array groups;
wherein the plurality of diode array sets are arranged longitudinally adjacent to one another and separated from one another by a set separation distance;
wherein the set separation distance is larger than the group separation distance.

18. The irradiation device of claim 17, comprising:
wherein the plurality of diode array sets comprises a first diode array set and a second diode array set, wherein a corresponding one of the plurality of laser diode arrays belonging to the first diode array set is configured to exhibit one or more irradiation parameters that differs from a corresponding one of the plurality of laser diode arrays belonging to the second diode array set, the one or more irradiation parameters comprising: beam power, beam intensity, intensity profile, wavelength, spot size, and/or spot shape.
